(19) United States
(12) Patent Application Publication
(10) Pub. No.: US 2023/0419336 A1
(43) Pub. Date: Dec. 28, 2023

(54) IDENTIFYING SHORTAGE ITEMS FROM A RETAIL ENVIRONMENT IN ONLINE MARKETPLACES

(71) Applicant: TARGET BRANDS, INC., Minneapolis, MN (US)

(72) Inventor: Ethan SOMMER, Minneapolis, MN (US)

(21) Appl. No.: 18/308,012

(22) Filed: Apr. 27, 2023

Related U.S. Application Data
(60) Provisional application No. 63/356,376, filed on Jun. 28, 2022.

(51) Int. Cl. G06Q 30/018; G06Q 20/20; G06Q 30/0601

(52) U.S. Cl. CPC G06Q 30/0185; G06Q 20/208; G06Q 30/0609

(57) ABSTRACT

The disclosed technology provides for for identifying items likely stolen from a physical retail environment, like a store, in an online marketplace. A method can include receiving, from item detection sensors in the store, item data indicating items leaving the store, receiving, from a checkout station, transaction data, identifying a subset in the item data that don't match items in the transaction data as an item shortage, grouping items in the subset into a cluster, retrieving, from a server system hosting an online marketplace, seller listing data including groups of items offered for sale associated with different online seller profiles, comparing the cluster to each of the groups to determine cluster similarity scores for the groups, and identifying, based on the cluster similarity scores, a particular group and a particular seller profile as having a greatest likelihood of listing the cluster of items for sale.

### INCORPORATION BY REFERENCE

This application claims priority to U.S. Provisional Application Ser. No. 63/356,376, filed on Jun. 28, 2022, the disclosure of which is incorporated by reference in its entirety.

### TECHNICAL FIELD

This document generally describes devices, systems, and methods related to identifying clusters of items from a shortage in a retail environment in online listings of online marketplaces.

### BACKGROUND

A retail environment, such as a physical store, can sell items of varying types and categories. Shoppers, or other customers, can walk around the retail environment and pick items off shelves that they desire to purchase. When a shopper is done collecting the items they wish to purchase, the shopper can go through a checkout process in the retail environment. The retail environment can include a checkout area near an exit or exits of the retail environment. The checkout area can include checkout lanes in which an employee of the retail environment scans the items that the shopper is purchasing. This can be a manual checkout lane. The checkout area can also include self-checkout stations. The self-checkout stations can include scanning devices that the shopper can use to scan the items they are purchasing and complete a checkout process on their own. Sometimes, a checkout process can be completed without having to go through the checkout area in the retail environment. For example, the shopper can order the items online and complete the transaction online (e.g., pay for the items). Then, the shopper can show up at the retail environment to pick up the items that they ordered. The shopper can pick up the items as a drive up order or by entering the retail environment.

Sometimes, customers can enter the retail environment, pick items off the shelves, and exit the retail environment without paying for one or more of those items. Sometimes, customers can go through a checkout process but may scan, or otherwise pay for, at a self-checkout station, only some of the items that they picked off the shelves. Sometimes, customers can enter the manual checkout lane and sweetheart the employee working there to avoid scanning and paying for one or more of the items. These actions can cause shortages in the retail environment. Customers who take items from the retail environment without paying for them may also sell one or more of those items in online marketplaces.

### SUMMARY

The document generally describes technology for identifying online e-fencing of shortage items that were previously stolen from a physical retail environment. A challenge with identifying shortage items that were physically stolen from a retail store and that are being offered for sale in an online marketplace is that the stolen items are virtually indistinguishable from identical, non-shortage items that are legitimately being offered for sale in the online marketplace. For example, while items include a barcode that uniquely identifies the product for scanners to read in a physical retail environment, each item of the same SKU will have the same barcode and will otherwise appear the same in an online listing in an online marketplace—there is typically no way to differentiate online listings of shortage items from non-shortage items (e.g., photos appear the same/similar, product description appears the same/similar). The disclosed technology provides solutions to this and/or other problems by comparing and identifying similar clusters of items that were stolen at or around the same time frame from a physical retail environment like a retail store with clusters of online listings being offered by individual or groups of online sellers in online marketplaces. For example, a shortage cluster can be identified for a retail store that experienced a shortage of items A, B, C, and D within a certain time window (e.g., 5 minutes, 10 minutes, 15 minutes, 30 minutes, 1 hour). The disclosed technology can scan for similar clusters, including subsets, of items provided by online sellers who are located within a geographic range of the retail store that experienced the shortage. For example, an online seller who is located within a threshold distance of the retail store (e.g., 10 miles, 20 miles, 50 miles, 200 miles) offering items B, C, D, and E for sale in an online marketplace can be identified as having a high probability of providing an e-fence of shortage items based on the similarity of the item clusters and the physical proximity.

The disclosed technology provides for clustering items from shortages in a retail environment and identifying online seller listings in an online marketplace that includes the clusters and/or items in the clusters. Shortage items can be detected as they are carried out of or otherwise leaving the retail environment. For example, RFID readers or other sensing technology can detect items at, near, and/or around an exit of the retail environment. RFID readings of item identifiers can be compared to transaction data to determine which items associated in the RFID readings match recent transaction data (e.g., transaction data for checkout processes completed within a past a hour or another predetermined amount of time). Items that do not match items in the transaction data can be clustered and identified as part of an item shortage in the retail environment. Such items might have been stolen by shoppers or other guests leaving the retail environment. The disclosed technology provides for checking seller listings in online marketplaces to determine whether any of those seller listings include the cluster of items or at least a portion of the cluster of items, which can prompt any of a variety of remedial actions, such as notifying the online marketplace to deactivate/suspend seller accounts, notifying authorities, and/or ordering one or more of the items to verify that such item(s) is in fact the shortage item(s) from the retail environment.

Seller listings can be assigned scores indicating likelihood that those listings are attributed to the item shortage. The scores can be determined using a set of parameters, such as geographic location/proximity of a seller to the retail environment. As a result, finding correlations between online seller listings and item shortages in the retail environment can be refined based on factors such as geographic proximity of a seller associated with the listing with the retail environment where the shortage occurred. The scores can also be based on whether the seller listings include the item(s) in the clusters and/or timing that the seller listings are made in the online marketplace(s) relative to timing of the item shortage in the retail environment. The scores can then be used to determine and objectively identify seller listings including the cluster(s) of items attributed to the item shortage in the retail environment.

One or more embodiments described herein can include a system for identifying items likely stolen from a physical retail environment in an online marketplace, the system including: a checkout station having at least one scanning device and a point of sale (POS) terminal, the checkout station being configured to scan items during a checkout process and generate transaction data upon completion of the checkout process, item detection sensors near an exit of a physical retail environment that can be configured to detect item identification tags fixed to the items that leave the physical retail environment, and a computer system in communication with the checkout station and the item detection sensors, the computer system being configured to identify items likely stolen from the physical retail environment in an online marketplace. The computer system can perform operations including: receiving, from the item detection sensors, item data indicating the items detected by the item detection sensors as leaving the physical retail environment, the item data including at least, for each item in the item data, an item identifier, an item type, and a timestamp at which the item was detected as leaving the physical retail environment, receiving, from the checkout station, the transaction data for checkout processes that have been completed at the checkout station, identifying a subset of items in the item data that do not match items in the transaction data as an item shortage in the physical retail environment, grouping items in the subset of items into a cluster based on a determination that the grouped items have timestamps within a threshold amount of time from each other, retrieving, from a server system hosting an online marketplace, seller listing data for the online marketplace, the seller listing data including groups of items offered for sale in the online marketplace that are each associated with a different one of a group of online seller profiles, comparing the cluster to each of the groups of items associated with the group of online seller profiles to determine cluster similarity scores for each of the groups of items, identifying, based on the cluster similarity scores, a particular group of items and a particular corresponding seller profile as having a greatest likelihood of listing the cluster of items in the online marketplace, and returning output in response to identifying the particular group of items and the particular corresponding seller profile that, when transmitted to a user computing device, causes the user computing device to perform an action based on the particular group of items as likely being stolen from the physical retail environment.

In some implementations, the embodiments described herein can optionally include one or more of the following features. For example, the transaction data can be received in real-time, as the checkout processes are completed at the checkout station. The transaction data can be received for a subset of checkout processes that are completed within a threshold amount of time from the timestamp for each item in the item data. The transaction data can include, for each completed checkout process, at least a timestamp at which the checkout process was completed and a list of item identifiers for items purchased during the checkout process. The seller listing data further can include, for each different one of the plurality of online seller profiles, a seller ID associated with the online seller profile, a list of item SKUs sold by the online seller profile, and a geographic location associated with the seller ID.

In some implementations, the embodiments described herein can optionally include one or more of the following features. For example, the transaction data can be received in real-time, as the checkout processes are completed at the checkout station. The transaction data can be received for a subset of checkout processes that are completed within a threshold amount of time from the timestamp for each item in the item data. The transaction data can include, for each completed checkout process, at least a timestamp at which the checkout process was completed and a list of item identifiers for items purchased during the checkout process. The seller listing data further can include, for each different one of the plurality of online seller profiles, a seller ID associated with the online seller profile, a list of item SKUs sold by the online seller profile, and a geographic location associated with the seller ID.

In some implementations, identifying, based on the cluster similarity scores, a particular group of items and a particular corresponding seller profile as having a greatest likelihood of listing the cluster of items in the online marketplace can include determining, based on the retrieved seller listing data, that the particular group of items was listed in the online marketplace by the particular seller profile within a threshold amount of time before the item shortage was identified in the physical retail environment. Sometimes, identifying, based on the cluster similarity scores, a particular group of items and a particular corresponding seller profile as having a greatest likelihood of listing the cluster of items in the online marketplace can include determining that the particular group of items was listed in the online marketplace by the particular seller profile within a threshold amount of time after the item shortage was identified in the physical retail environment. As another example, identifying, based on the cluster similarity scores, a particular group of items and a particular corresponding seller profile as having a greatest likelihood of listing the cluster of items in the online marketplace can include determining that a geographic location associated with the particular seller profile is within a threshold distance from the physical retail environment. As another example, identifying, based on the cluster similarity scores, a particular group of items and a particular corresponding seller profile as having a greatest likelihood of listing the cluster of items in the online marketplace can include determining that a geographic location associated with the particular seller profile is within a threshold radius from the physical retail environment.

In some implementations, comparing the cluster to each of the groups of items associated with the group of online seller profiles to determine cluster similarity scores for each of the groups of items can include: assigning a cluster match score to one of the group of online seller profiles above a first threshold value based on a determination that the online seller profile includes a threshold quantity of the cluster of items, assigning a location score to the online seller profile above a second threshold value based on a determination that a geographic location of the online seller profile is within a threshold distance from a geographic location of the physical retail environment, and generating a cluster similarity score for the online seller profile based on aggregating the cluster match score and the location score, the cluster similarity score indicating a likelihood that the online seller profile is associated with the item shortage in the physical retail environment. Sometimes, identifying, based on the cluster similarity scores, a particular group of items and a particular corresponding seller profile as having a greatest likelihood of listing the cluster of items in the online marketplace can include identifying the particular corresponding seller profile having a cluster similarity score that exceeds a threshold confidence value.

In some implementations, returning output in response to identifying the particular group of items and the particular corresponding seller profile can include generating instructions that, when transmitted and executed at the user computing device, causes the user computing device to purchase one or more items in the particular group of items, the purchased one or more items being compared to the cluster to verify that the purchased one or more items correspond to the cluster of items identified in the item shortage in the physical retail environment. Returning output in response to identifying the particular group of items and the particular corresponding seller profile can also include associating a seller ID linked to the particular seller profile with a shopper in the physical retail environment, the shopper being objectively identified in the physical retail environment, by the computer system, based on at least one of image data of the shopper in the physical retail environment and an objective identifier associated with the shopper, the objective identifier being at least one of a MAC address of a mobile device of the shopper, an email address, a phone number, and a credit card number. Returning output in response to identifying the particular group of items and the particular corresponding seller profile can also include generating instructions that, when executed at the user computing device, cause an actor in the online marketplace to freeze the particular seller profile for a threshold period of time to prevent the particular seller profile from at least one of selling items, completing sales, and receiving payment from buyers. In some implementations, returning output in response to identifying the particular group of items and the particular corresponding seller profile can include: generating a report for law enforcement identifying the particular group of items, the particular seller profile, and items associated with the item shortage in the physical retail environment and transmitting the report to a law enforcement computing device for use in investigating and stopping the particular seller profile from selling the particular group of items associated with the item shortage in the physical retail environment.

In some implementations, the item detection sensors can include RFID readers positioned (i) inside the physical retail environment near an exit of the physical retail environment and (ii) outside the physical retail environment near the exit of the physical retail environment. Sometimes, each of the online seller profiles identifies a geographic location for a corresponding seller, and the computer system can perform operations including: selecting a subset of the seller profiles with geographic locations that may be within a threshold distance of the physical retail environment and comparing the cluster to each of the groups of items associated with the subset of seller profiles to determine cluster similarity scores for each of the groups of items.

One or more embodiments described herein include a method for identifying items likely stolen from a physical retail environment in an online marketplace, the method including: receiving, from item detection sensors near an exit of a physical retail environment configured to detect item identification tags fixed to items that leave the physical retail environment, item data indicating the items detected by the item detection sensors as leaving the physical retail environment, the item data including at least, for each item in the item data, an item identifier, an item type, and a timestamp at which the item was detected as leaving the physical retail environment, receiving, from a checkout station that can be configured to scan items during a checkout process and generate transaction data upon completion of the checkout process, the transaction data for checkout processes that have been completed at the checkout station, identifying a subset of items in the item data that do not match items in the transaction data as an item shortage in the physical retail environment, grouping items in the subset of items into a cluster based on a determination that the grouped items have timestamps within a threshold amount of time from each other, retrieving, from a server system hosting an online marketplace, seller listing data for the online marketplace, the seller listing data including groups of items offered for sale in the online marketplace that are each associated with a different one of a group of online seller profiles, comparing the cluster to each of the groups of items associated with the group of online seller profiles to determine cluster similarity scores for each of the groups of items, identifying, based on the cluster similarity scores, a particular group of items and a particular corresponding seller profile as having a greatest likelihood of listing the cluster of items in the online marketplace, and returning output in response to identifying the particular group of items and the particular corresponding seller profile that, when transmitted to a user computing device, causes the user computing device to perform an action based on the particular group of items as likely being stolen from the physical retail environment.

The method can optionally include one or more of the abovementioned features. The method can optionally also include one or more of the following features. For example, returning output in response to identifying the particular group of items and the particular corresponding seller profile can include associating a seller ID linked to the particular seller profile with a shopper in the physical retail environment, the shopper being objectively identified in the physical retail environment, by the computer system, based on at least one of image data of the shopper in the physical retail environment and an objective identifier associated with the shopper, the objective identifier being at least one of a MAC address of a mobile device of the shopper, an email address, a phone number, and a credit card number. As another example, the method can include identifying, based on the cluster similarity scores, a particular group of items and a particular corresponding seller profile as having a greatest likelihood of listing the cluster of items in the online marketplace comprises determining that a geographic location associated with the particular seller profile is within a threshold distance from the physical retail environment.

The devices, system, and techniques described herein may provide one or more of the following advantages. For example, RFID and other item sensing technology in the retail environment can be leveraged to objectively detect e-fencing of items likely to be stolen from the retail environment. Detecting the e-fencing can be beneficial to identify causes of item shortages in the retail environment. As a result of detecting e-fencing of shortaged items, the retail environment can determine appropriate actions to resolve the shortage(s). For example, the disclosed technology can provide for objectively associating a seller listing having the shortaged items with a shopper in the retail environment. The shopper can be monitored and/or stopped during subsequent trips to the retail environment to ensure that they do not take more items and sell them in the online marketplace. The disclosed technology can also provide for generating reports for law enforcement, which can then be used to monitor a seller associated with the seller listing(s) and/or a shopper who is likely linked to the seller listing(s). The disclosed technology can also provide for freezing a seller account associated with the seller listing(s) to prevent the seller from continuing to sell the shortaged items. One or more other remediations can be generated and taken in response to detecting e-fencing using the disclosed techniques. Such remediations can be beneficial to respond to and/or reduce item shortages in the retail environment. Such remediations can also be beneficial to proactively deter item shortages in the future at the retail environment.

Similarly, the disclosed technology can leverage existing technology, systems, computer infrastructure, and human observations in the retail environment to cluster shortage items and/or detect e-fencing of the clustered items. RFID readers and other sensor devices in the retail environment can be used to monitor what items leave the retail environment. Existing checkout systems and/or computer systems associated with the retail environment can also be leveraged to correlate items leaving the retail environment with transaction data and determine which items leaving the retail environment are likely being stolen/part of an item shortage. The existing computer systems can further be used to objectively identify seller listings in online marketplaces that are selling the stolen items. Moreover, an employee in the retail environment can observe a customer leaving the retail environment with particular items and document their observations in the existing computer system. The disclosed technology can then use those documented observations to match and identify one or more of the particular items in seller listings in an online marketplace. In some implementations, the disclosed technology can also be retrofitted/implemented at a low cost in retail environments having different existing technology, systems, and/or computer infrastructure.

Leveraging existing technology in the retail environment can be computationally efficient and use less processing power and/or compute resources. The disclosed technology can provide access to a variety of data stored about the retail environment and online marketplaces, which, used in combination with the existing technology in the retail environment, can provide for accurate and efficient clustering of shortage items and e-fencing detection. Signals for items that are detected as they leave the retail environment can be quickly processed and clustered in seconds, in real-time, and/or in near real-time. The cluster of items can then be used along with a set of one or more parameters to efficiently search online listings in an online marketplace and detect e-fencing of the clustered items. Thus, the disclosed technology provides for leveraging computational resources of the retail environment to efficiently, accurately, and quickly identify e-fencing linked to item shortages in the retail environment.

As another example, the disclosed technology provides for objectively detecting e-fencing without having to identify particular shoppers and/or attributing activities in the retail environment and online marketplaces to the particular shoppers. Instead, the disclosed technology provides for correlating clusters of items associated with an item shortage with parameters, such as geographic proximity, to identify sale of the clustered items in the online marketplaces.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram for clustering items associated with a shortage in a retail environment and identifying the cluster(s) in seller listings in an online marketplace.

FIG. 1B is a conceptual diagram for associating seller listings in the online marketplace with item shortages in retail environments.

FIG. 2 is a flowchart of a process for clustering items associated with a shortage in a retail environment and identifying the cluster(s) in seller listings in an online marketplace.

FIG. 3 is a flowchart of a process for identifying items associated with a shortage in a retail environment.

FIGS. 4A-B is a flowchart of a process for identifying a cluster of items associated with a shortage in a seller listing in an online marketplace.

FIG. 5 is a system diagram of components used to perform the techniques described herein.

FIG. 6 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to technology for automatically identifying e-fencing of stolen items via online marketplaces based on correlating items offered for sale in the online marketplaces and clustered item shortages in a retail environment. The disclosed technology can identify item shortages in the retail environment based on detecting items that leave the retail environment using RFID tags and readers and comparing those items to transaction data in the retail environment. Items identified in the shortages can be clustered. The items can be clustered based on their unique identifiers, or RFID tags, being detected as leaving the retail environment at or around the same time. This can indicate that the items are likely being taken/stolen by the same shopper. The clusters can be used in combination with one or more parameters, such as geographic proximity and timestamps, to score seller listings in the online marketplaces that may be selling the clustered items. The scores can then be used to determine which seller listing is selling the clustered items and thus likely associated with the item shortage in the retail environment. One or more actions can be generated and taken in response to identifying that the seller listing is selling the clustered items and thus associated with the item shortage in the retail environment.

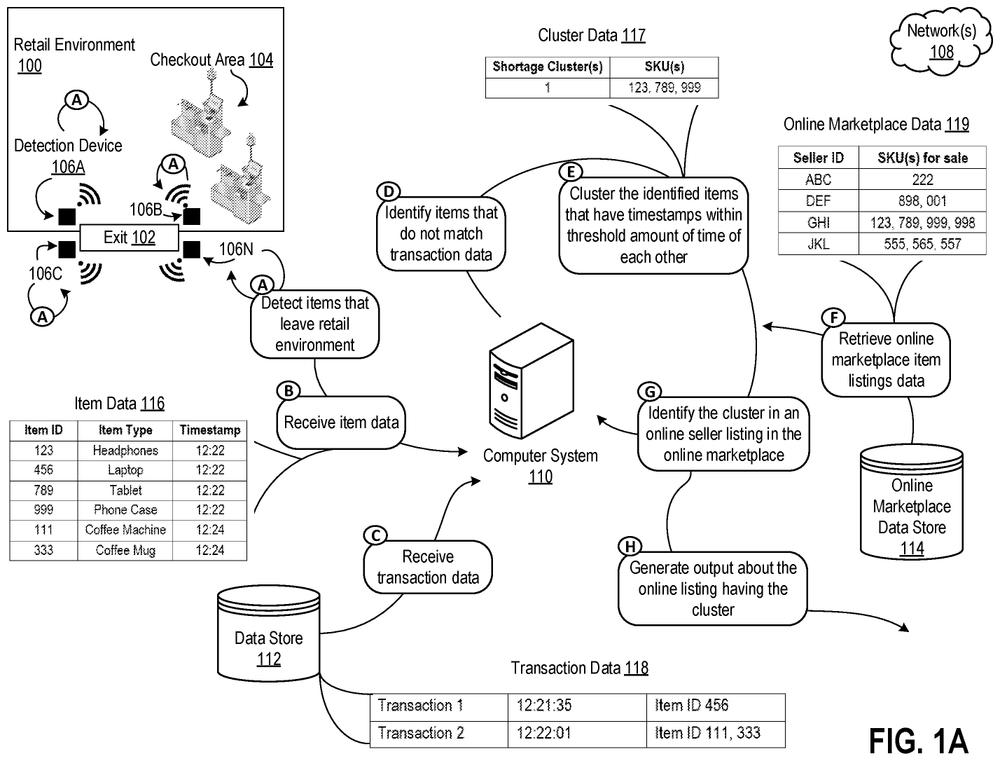

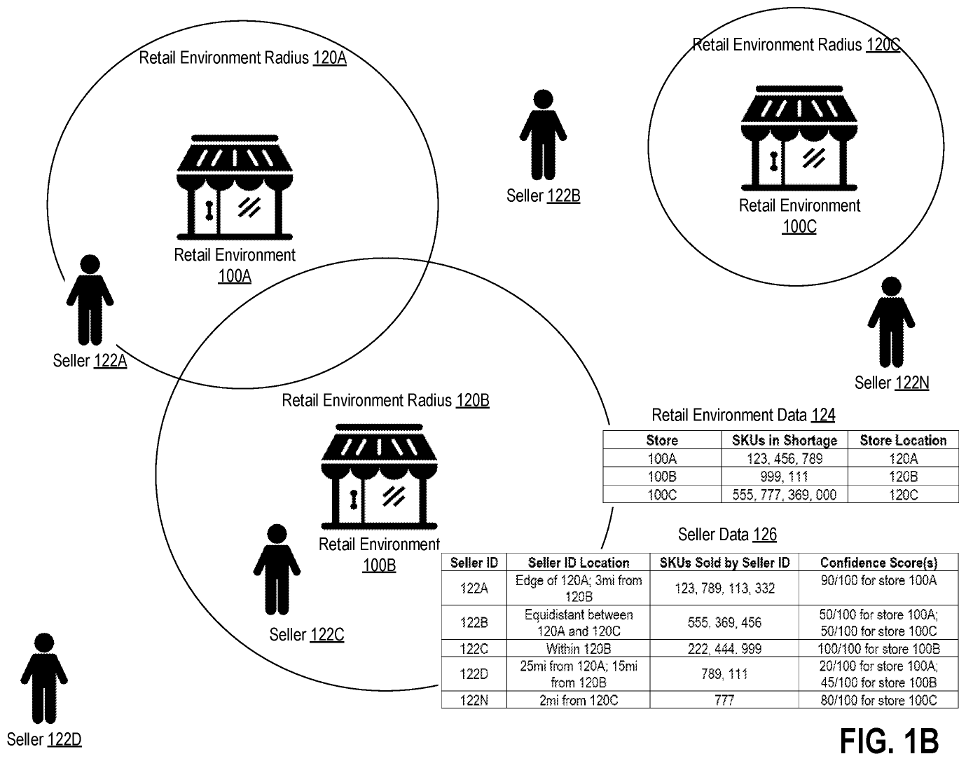

Referring to the figures, FIG. 1A is a conceptual diagram for clustering items associated with a shortage in a retail environment 100 and identifying the cluster(s) in seller listings in an online marketplace. The retail environment 100 can be a physical store that sells a variety of items for purchase by shoppers (e.g., consumers). The retail environment 100 can be a store that is part of a network of stores. The retail environment 100 can also be a standalone store of shop. The retail environment 100 can offer a variety of services to shoppers. For example, the retail environment 100 can offer order pickup services. A shopper can place an order online and then pick up their order at the retail environment 100. The shopper can pick up the order by entering the retail environment 100, showing their order confirmation or account information to an employee in an order pickup area of the retail environment 100, and then leaving the retail environment 100 with their order. As another example, the shopper can pick up the order by driving up to the retail environment 100 and waiting in their vehicle as an employee of the retail environment 100 brings the order to their vehicle. In some implementations, a third party can shop on behalf the shopper. The shopper can place an order online. Once the order is placed/paid for, the third party can enter the retail environment 100, scan items in the order off the shelves, and leave the retail environment 100 with the scanned items for the order. The third party may not undergo a checkout process at the retail environment 100 since the shopper already paid when the order was placed. One or more other shopping services may be available at the retail environment 100.

Devices, components, and systems of the retail environment 100 can communicate (e.g., wired and/or wireless) with a computer system 110, data store 112, and/or online marketplace data store 114 via network(s) 108. The retail environment 100 can include a checkout area 104 positioned near an exit 102 of the retail environment 100. The checkout area 104 can include one or more checkout stations and/or checkout lanes. The checkout stations and/or lanes can be self-checkout lanes. Additionally or alternatively, the checkout stations and/or lanes can include manual checkout lanes manned by employees of the retail environment 100. Once shoppers complete their shopping and selection of items in the retail environment 100, the shoppers can complete checkout processes in the checkout area 104 to purchase those items. Once the checkout processes are completed, the shoppers can exit the retail environment 100 through the exit 102.

One or more detection devices 106A-N can be positioned at, around, or near the exit 102 of the retail environment 100. For example, one or more detection devices 106A and 106B can be positioned inside the retail environment 100 on opposite sides of the exit 102. One or more other detection devices 106C and 106N can be positioned outside the retail environment 100 on opposite sides of the exit 102. One or more other configurations of the detection devices 106A-N can also be used. For example, one or more detection devices 106A-N can be positioned in the exit 102. As another example, one or more detection devices 106A-N can be positioned above the exit 102 and/or above an area inside the retail environment 100 before the exit 102 and/or an area outside the retail environment 100 after the exit 102.

The detection devices 106A-N can be RFID readers. The detection devices 106A-N can be configured to detect RFID tags of items as they leave the retail environment 100. The detection devices 106A-N can have a predetermined detection range in which they can detect RFID tags. The detection range can be sufficiently sized around the exit 102 of the retail environment 100 so that the detection devices 106A-N do not pick up the RFID tags of items that are remaining in the retail environment 100, such as items that are being carried by a shopper from one end of the retail environment 100 to the other before or after the shopper completed the checkout process and/or items that are being brought into the retail environment 100 to be returned. In some implementations, the items may have different types of unique identifiers attached to them. For example, the items can include barcodes, SKUs, and other unique identifiers. The detection devices 106A-N can be configured to detect one or more of the other types of unique identifiers that may be attached to or otherwise part of the items that leave the retail environment 100. For example, the detection devices 106A-N can include cameras that capture images of barcodes, SKUs, or other parts of the items that can be used for identifying the particular items leaving the retail environment 100. The detection devices 106A-N can also include scanners that can detect and/or scan barcodes, SKUs, or other unique identifiers of items as the items pass by the detection devices 106A-N. Moreover, multiple detection devices 106A-N can be positioned around the exit 102 in order to increase accuracy of detecting items as they leave the retail environment 100. As an example, detections of the same item that are made inside and outside the exit 102 can be correlated to identify an exit event of the item from the retail environment 100.

The computer system 110 can be any type of computing system, device, cloud-based system, and/or network of devices. The computer system 110 can be located in or near the retail environment 100. The computer system 110 can also be remote from the retail environment 100. In some implementations, the computer system 110 can be used by multiple retail environments in a network or group of retail environments.

The data store 112 can be any type of database, data storage system/device, repository, and/or cloud-based storage. The data store 112 can be separate from the computer system 110, the online marketplace data store 114, and/or components/devices of the retail environment 100. In some implementations, the data store 112 can be part of the computer system 110.

The online marketplace data store 114 can also be any type of database, data storage system/device, repository, and/or cloud-based storage. The data store 114 can be separate from the computer system 110 and the data store 112. In some implementations, multiple online marketplace data stores can be in communication with the computer system 110 via the network(s) 108. For example, each online marketplace can have their respective data store.

An online marketplace is an e-commerce website where item and/or service information can be provided by multiple third party sellers. The third party sellers can have seller profiles through which they list various items and/or services for sale and purchase by online shoppers. The seller listings can include auctions, in which shoppers can bid on prices of the items in the auctions. The seller listings can also include fixed price buys in which shoppers purchase the items for the prices listed by the sellers. A seller listing can remain up on the online marketplace until a predetermined period of time expires (e.g., a 7 day auction), a shopper purchases the item(s) in the seller listing, and/or the listing is taken down (e.g., by the seller, by the online marketplace).

Still referring to FIG. 1A, once a shopper completes the checkout process in the checkout area 104 of the retail environment 100, the shopper can proceed to the exit 102. The shopper can carry their purchased items in bags, a shopping cart, a shopping basket, or their hands. As the shopper comes in range of the detection devices 106A-N around the exit 102, the detection devices 106A-N can detect RFID tags on the shopper's purchased items (block A).The detection devices 106A-N can generate item data 116 for items that are detected as they leave the retail environment 100. The item data 116 can be generated in real-time, as item RFID tags are detected by the detection devices 106A-N. The item data 116 can also be generated in near real-time or at predetermined time intervals. As a result, the item data 116 can be generated in bulk for various items that leave the retail environment 100 during some period of time (e.g., 1 minute, 2 minute, 3 minute, 5 minute, 10 minute windows of time, etc.).

The item data 116 can include at least an item ID, item type, and timestamp of detection. The item ID can be a unique identifier that corresponds to the detected RFID tag of the item as the item leaves the retail environment 100. The item type can indicate a type of the item that leaves the retail environment 100, which can be determined by the detection devices 106A-N based on detection of the RFID tag for the item. The timestamp can indicate a time at which the detection devices 106A-N detect the item at or near the exit 102. In some implementations, the item data 116 can include multiple entries for the same item that is detected leaving the retail environment 100. Each entry can include the corresponding item ID, type, and timestamp as detected/determined by a different detection device. The computer system 110 can then correlate the entries having the same item ID to generate an accurate entry for the item. In some implementations, multiple detection devices 106A-N can detect the same item as it leaves the retail environment 100. These multiple detections can be combined/associated with each other in the item data 116 to generate a single entry for the item in the item data 116. The item data 116 can then be transmitted to the computer system 110 in block B.

The computer system 110 can receive the item data 116 from the detection devices 106A-N (block B). As mentioned above in reference to generating the item data 116, the item data 116 can be transmitted in real-time, as the item RFID tags are detected. The item data 116 can also be transmitted in bulk or batches at predetermined time intervals (e.g., every 30 seconds, 1 minute, 2 minutes, 3 minutes, 5 minutes, etc.).

The computer system 110 can also receive transaction data 118 from the data store 112 (block C). The computer system 110 can receive all the transaction data 118 in real-time, as transactions are completed in the checkout area 104. The computer system 110 can also request and receive the transaction data 118 for a threshold or predetermined period of time, such as several minutes before and/or after one or more of the timestamps received as part of the item data 116. For example, the item data 116 includes an item having the ID of 123 and a timestamp of 12:22. The computer system 110 can then request and retrieve all transaction data 118 having timestamps between 12:18-12:25 from the data store 112. This transaction data 118 can then be used to determine whether the item having the ID of 123 was logged in any of the transactions between 12:18-12:25. If the item was logged in a transaction during that time, then the item was purchased by a shopper. If the item was not logged in a transaction during that time, then the item was likely stolen and carried out of the retail environment 100 without being paid for. The threshold period of time for which to receive the transaction data 118 can also vary. For example, the threshold period of time can be 5 minutes before an earliest timestamp in the item data 116, 5 minutes before a latest timestamp in the item data 116, 2-5 minutes before the earliest timestamp and 2-5 minutes after the latest timestamp, etc. The threshold period of time can also vary depending on a distance between the exit 102 and the checkout area 104. For example, the farther away the checkout area 104 is from the exit 102, the more time shoppers would need between completing their transactions in the checkout area 104 and exiting the retail environment through the exit 102. Therefore, the threshold period of time can be longer than if the checkout area 104 is closer in distance to the exit 102.

The transaction data 118 can include information associated with each transaction that occurs in the checkout area 104 in the retail environment 100. For example, the transaction data 118 can include an identifier for each transaction, a timestamp at which the transaction was completed, and identifiers for the item(s) that were purchased during the transaction. The transaction data 118 can include additional or alternative information. For example, the transaction data 118 can include payment information, user account information associated with the retail environment 100, or other unique identifiers for identifying the shopper who purchased the item(s) in the transaction.

Once the computer system 110 has the item data 116 (block B) and the transaction data 118 (block C), the computer system 110 can identify items that do not match the transaction data 118 in block D. In other words, the computer system 110 can assess the transaction data 118 to identify transactions containing the item identifiers found in the item data 116. Items that appear in the item data 116 but not in the transaction data 118 likely were stolen or otherwise taken out of the retail environment 100 without being paid. These items are be identified as part of a shortage in the retail environment 100. Moreover, items that do not match the transaction data 118 but have a same or similar timestamp as other items that do match the transaction data 118 are likely taken from the retail environment 100 by the same shopper. Accordingly, the computer system 110 can cluster the identified items that have timestamps within a threshold amount of time of each other (block E). The threshold amount of time can be any one or more amounts of time, including but not limited to 10 seconds, 15 seconds, 20 seconds, 30 seconds, 1 minute, 2 minutes, 3 minutes, etc. The computer system 110 can generate cluster data 117 to identify items that are attributed to the shortage in the retail environment 100 and likely stolen by the same shopper. The cluster data 117 can be used to search seller listings in online marketplaces to objectively identify e-fencing of the clustered items, as described further herein.

The cluster data 117 can include a cluster identifier and SKUs or other item identifiers associated with the cluster. In the example of FIG. 1A, the cluster data 117 includes a shortage cluster 1 having three items identified by their SKUs 123, 789, and 999. These items are clustered together because, as shown in the item data 116, they all have the same timestamp of 12:22 when they left the retail environment 100. Their timestamps are within a threshold amount of time of each other (they are the same), so they are likely removed from the retail environment 100 by the same shopper. Moreover, since these items have the same timestamp as the item 456, these items are likely associated with the item 456 which, as shown in the transaction data 118, was purchased in transaction 1 at 12:21:35. The items 123, 789, 999 are likely associated with the shopper of the transaction 1.

The computer system 110 can retrieve online marketplace item listings data 119 from the online marketplace data store 114 in block F. The computer system 110 can retrieve the data 119 before, during, or after one or more other blocks described in FIG. 1A. For example, the computer system 110 can retrieve the data 119 in block F before receiving the item data 116 in block B and/or before receiving the transaction data 118 in block C. The computer system 110 can also retrieve the data 119 at a same or similar time as performing blocks B and/or C.

The computer system 110 can receive the data 119 in real-time, as seller listings are listed/appear in the online marketplaces. The computer system 110 can also receive all the seller listings that are listed/appear in the online marketplaces before and after the timestamps associated with transactions in the transaction data 118. The computer system 110 can also refine parameters for requesting and receiving/retrieving the data 119. For example, the computer system 110 may receive seller listings for a variety of online marketplaces. The computer system 110 may receive seller listings for only some online marketplaces. The computer system 110 may also request the data 119 for a specified time period, such as 1 day before the earliest transaction in the transaction data 118 and 1 day after the latest transaction in the transaction data 118. The computer system 110 may also request the data 119 for a specified geographic region/location. For example, the computer system 110 may request the data 119 for seller listings that include a location within a predetermined radius or distance from the retail environment 100 (e.g., 0-10 mile distance from the retail environment 100, 0-25 mile, 0-100 mile, within a 1-mile radius, within a 5-mile radius, within a 10-mile radius, etc.). In some implementations, the computer system 110 can receive the data 119 that satisfies item type criteria. For example, the computer system 110 can request the seller listing data 119 for items having a type corresponding to the type of items that were identified in the cluster data 117 (e.g., if only electronic devices are identified in the cluster data 117 as being associated with a shortage, the computer system 110 can request seller listings for electronic devices from the data store 114).

The online marketplace data 119 can include seller IDs and SKUs or other unique identifiers for items listed for sale by each seller ID. The data 119 can also include timestamps at which the sellers listing the items for sale. The data 119 can also include item type data, geographic locations associated with the seller and/or the items listings associated with the seller, and/or other seller-identifying information. Although the data 119 may list multiple items for sale by a seller, each of those items can be in a separate listing in the online marketplace. For example, seller GHI is selling items 123, 789, 999, and 998. Each of these items can be listed in a separate seller listing in the online marketplace by the same seller.

In some implementations, the computer system 110 can also receive online marketplace APIs in block F. The computer system 110 can then use the APIs to search for seller listings in the data 119 for the online marketplaces.

Using the data 119, the computer system 110 can identify the cluster from the cluster data 117 in an online seller listing in the online marketplace (block G). The computer system 110 can use one or more parameters described herein, such as geographic proximity of the seller to the retail environment 100, timing of the seller listing relative to the time that the item leaves the retail environment 100, and item type, to efficiently, accurately, and objectively search the data 119 to identify a seller who likely is selling at least one of the clustered items in the data 117. Using the APIs, for example, the computer system 110 can search the data 119 for seller listings containing the same SKU or other item identifier and/or item type as the items clustered in the cluster data 117.

In the example of FIG. 1A, the cluster 1 includes items 123, 789, and 999. Seller GHI is identified as selling items 123, 789, 999, and 998. Although seller GHI is selling item 998, which is not associated with the shortage in the retail environment 100, seller GHI is likely the shopper who took the items 123, 789, and 999 out of the retail environment 100 with the item 456 that was purchased in transaction 1. Seller GHI's listings for items 123, 789, and 999 can be identified in block G.

As described further below, identifying the cluster in the online seller listing(s) in block G can include scoring the seller listings in the data 119. A score can indicate a likelihood that the seller listing contains the cluster of shortage items and/or at least one of the clustered shortage items. The score can vary depending on a distance between the retail environment 100 and the seller listing (e.g., the farther the seller listing is from the retail environment 100, the lower the score and the less likely the seller listing is associated with the shortage). The score can also vary depending on a time at which the seller listing is made/appears in the online marketplace relative to the time the shortage was identified in the retail environment 100 (e.g., the more time that passes between the seller listing appearing in the marketplace and the identification of the shortage event, such as the clustering in block E, the lower the score). As another example, the score can vary depending on how many of the items in the cluster are identified in seller listings made by the same seller (e.g., the fewer the clustered items that appear in the seller listings associated with the same seller, the lower the score). The computer system 110 can then attribute the seller listings and the associated seller to the shortage in the retail environment 100 based on a determination of whether the score satisfies threshold scoring criteria (e.g., the score exceeds a threshold score value, such as 60 out of 100, 65 out of 100, 70 out of 100, 80 out of 100, 90 out of 100, etc.).

Once the cluster is identified in the online seller listing(s), or a threshold amount of the items in the cluster (e.g., 80% of the items in the cluster, 75% of the items, 85% of the items, 90% of the items, etc.), the computer system 110 can generate output about the online listing having the cluster in block H. As described further below, the output can include a report that is transmitted to law enforcement. The report can identify the seller associated with the online seller listing(s) and the clustered shortage items being sold in the listing(s). The output can include an alert to one or more parties in the retail environment 100 and/or the online marketplace indicating that the seller associated with the online seller listing(s) should be monitored and/or stopped. One or more other outputs may also be generated.

FIG. 1B is a conceptual diagram for associating seller listings in the online marketplace with item shortages in retail environments 100A-B. The retail environments 100A, 100B, and 100C can be part of a network, chain, or group of retail environments. One or more of the retail environments 100A, 100B, and 100C can be physically/geographically proximate to each other. For example, the retail environments 100A, 100B, and 100C can be distanced from each other within a designated geographic region/area. Another geographic region/area can then include one or more other retail environments that are physically distanced from each other within that geographic region/area.

Each of the retail environments 100A, 100B, and 100C have a respective radius 120A, 120B, and 120C. The radiuses 120A-C can vary. The retail environments 100A-C can have the same radiuses 120A-C. The retail environments 100A-C can also have different radiuses 120A-C. For example, bigger retail environments that seller more items can have bigger radiuses. As another example, retail environments in more population-dense communities/areas can have bigger radiuses. As yet another example, retail environments in cities can have smaller radiuses than retail environments in rural areas. Example radiuses can include, but are not limited to, 5 miles, 10 miles, 15 miles, 20 miles, 25 miles, 50 miles, etc.

The radiuses 120A-C can be any other measurement of distance measured from the respective retail environments 100A-C. For example, the radiuses 120A-C can be threshold/predetermined physical distances from the respective retail environments 100A-C. Each radius 120A-C can be, as an illustrative example, a threshold distance of 10 miles from the respective retail environment 100A-C. As mentioned above, each radius 120A-C can also be a different threshold distance from the respective retail environment 100A-C. As another example, the radiuses 120A-C can be specified geographic areas, regions, or other locations. The radius 120A of the retail environment 100A can, for example, be a particular county or a particular town in a geographic region. The radius 120B of the retail environment 100B can then be associated with another country or another town in the same (or different) geographic region.

Moreover, in some implementations, one or more of the radiuses 120A-C can overlap. In the example of FIG. 1B, the radiuses 120A and 120B overlap.

Various sellers 122A-N can sell items in seller listings. As described in FIG. 1A, one or more of the sellers 122A-N may sell items that are identified in clusters of shortage items for any of the retail environments 100A-C. Each of the sellers 122A-N can also be associated with geographic locations/areas from which they sell the items and/or list the items in the seller listings. Data about the sellers 122A-N and their respective listings can be used to identify which, if any, of the sellers 122A-N are selling the clustered shortage items.

Retail environment data 124 and seller data 126 can be used to identify seller listings for items that are clustered and associated with shortages in any of the retail environments 100A-C. The retail environment data 124 can include a retail environment (e.g., store) identifier (100A-C), SKUs or other item identifiers for items that are part of a shortage for the respective retail environment, and a location of the retail environment (e.g., the radiuses 120A-C).

The seller data 126 can include a seller ID, a location of the seller ID (e.g., a location that a seller identifies themselves with in the online marketplace), SKUs or other item identifiers for items sold in seller listings by the seller ID, and confidence scores indicating likelihood that the seller listings of the seller ID are linked/attributed to the shortages in the retail environments. In brief, the farther away the seller ID's location from a retail environment and/or a radius of the retail environment, the less likely the seller ID is associated with a shortage in that retail environment. Therefore, the seller ID's confidence score may be lower with respect to the shortage in that retail environment. The closer the seller ID's location is to the retail environment and/or the radius of the retail environment, the more likely the seller ID is associated with the shortage in that retail environment. Therefore, the seller ID's confidence score can be higher with respect to the shortage in that retail environment—especially if the seller ID is also selling at least a threshold quantity of items from the cluster of shortage items for that retail environment.

In the example retail environment data 124 in FIG. 1B, the retail environment 100A has SKUs 123, 456, and 789 in shortage, meaning the items corresponding to these SKUs have been identified as being stolen by a shopper at the retail environment 100A. These SKUs may be clustered together. In some implementations, less than all these SKUs can be clustered together based on their timestamps. For example, SKUs 123 and 789 can be clustered together because they have a same timestamp or a timestamp within a threshold amount of time of each other, thereby indicating that the SKUs 123 and 789 were likely removed from the retail environment 100A by the same shopper at the same time. SKU 456 may not be clustered with SKUs 123 and 789 because SKU 456 may have a timestamp that is hours before or after the timestamp of the SKUs 123 and 789. Still referring to the retail environment data 124, the retail environment 100B can have SKUs 999 and 111 in shortage. The retail environment 100C can have SKUs 555, 777, 369, and 000 in shortage.

In the example seller data 126, the seller 122A is located along/at the edge of the radius 120A of the retail environment 100A and 3 miles away from the radius 120B of the retail environment 100B (or 3 miles away from the retail environment 100B, in some implementations). The seller 122A is selling SKUs 123, 789, 113, and 332 from their location. The seller 122A has a confidence score of 90 out of 100 ( 90/100) for the shortage in the retail environment 100A. The seller 122A has a confidence score for the shortage in the retail environment 100A because seller 122A is not selling any SKUs associated with shortages in the other retail environments 100B-C. Moreover, seller 122A's confidence score is 90/100 because (i) seller 122A is selling two SKUs that are in shortage at the retail environment 100A (SKUs 123 and 789) and (ii) seller 122A is along the edge of the radius 120A of the retail environment 100A. Seller 122A can be within a threshold distance from the retail environment 100A, thereby making seller 122A more likely to be selling items in shortage at the retail environment 100A in comparison to sellers like seller 122N. Seller 122A is likely selling stolen items from the retail environment 100A and therefore is associated with the shortage at the retail environment 100A.

The seller 122B is equidistant from the retail environments 100A and 100C (e.g., equidistant from the respective radiuses 120A and 120C, equidistant from the respective retail environments 100A and 100C). Seller 122B is selling item SKUs 555, 369, and 456. Seller 122B also has a confidence score of 50/100 for the retail environment 100A and a confidence score of for the retail environment 100C. Seller 122B is selling one SKU (SKU 456) that was identified in the shortage at the retail environment 100A. Because seller 122B is located outside the radius 120A (or outside a threshold distance from the retail environment 100A, which is identified by the radius 120A in FIG. 1B), it is possible that seller 122B is associated with the shortage of the item SKU 456, but it is not as certain as if the seller 122B was within the radius 120A or the threshold distance from the retail environment 100A. Therefore, seller 122B has the confidence score of 50/100 for the shortage in the retail environment 100A. Seller 122B also has the confidence score of 50/100 for the shortage in the retail environment 100C because although they are selling the item SKUs 555 and 369 in shortage at the retail environment 100C, the seller 122B is outside the radius 120C or the threshold distance from the retail environment 100C. As described herein, the farther away a seller is from a retail environment, the lower their respective confidence score.

The seller 122C is within the radius 120B of the retail environment 100B (or is within a threshold distance from the retail environment 100B). Seller 122C is selling item SKUs 222, 444, and 999. Seller 122C has a confidence score of 100/100 for the retail environment 100B because seller 122C (i) is selling the item SKU 999 associated with the shortage in the retail environment 100B and (ii) is located within the radius 120B. Because the seller 122C is so physically close to the retail environment 100B, the seller 122C is most likely associated with the shortage of the item SKU 999. Therefore, seller 122C's confidence score is so high. The other item SKUs sold by seller 122C are not associated with a shortage in any of the other retail environments 100A or 100C.

The seller 122D is approximately 25 miles away from the radius 120A (or 25 miles away from the retail environment 100A) and 15 miles away from the radius 120B (or 15 miles away from the retail environment 100B). Seller 122D is selling item SKUs 789 and 111. Seller 122D has a confidence score of 20/100 for the retail environment 100A and a confidence score of 45/100 for the retail environment 100B. Although seller 122D is selling the item SKU 789, which is associated with the shortage at the retail environment 100A, seller 122D is so far away from the retail environment 100A (25 miles away) that their confidence score for the retail environment 100A is so low, at 20/100. Similarly, although seller 122D is selling the item SKU 111, which is associated with the shortage at the retail environment 100B, seller 122D is far enough away from the retail environment 100B (15 miles away) to have a low confidence score for the retail environment 100B ( 45/100).

In some implementations, seller 122D's confidence scores can be increased based on one or more additional parameters. For example, the confidence score for the retail environment 100A can be increased by a predetermined amount if the item type of the SKU 789 in seller 122D's listing matches the item type of the SKU 789 identified in the shortage at the retail environment 100A. As another example, the confidence score for the retail environment 100A can be increased by a predetermined amount if a time at which seller 122D lists the item SKU 789 is within a threshold amount of time from a time at which the shortage in the retail environment 100A was identified. Seller 122D's confidence scores can be increased or decreased based on one or more other parameters/factors described herein.

Still referring to the seller data 126, the seller 122N is located 2 miles away from the radius 120C (or 2 miles away from the retail environment 100C). Seller 122N is selling item SKU 777 and has a confidence score of 80/100 for the retail environment 100C. Seller 122N has the confidence score 80/100 because (i) the seller 122N is selling an item identified in the shortage at the retail environment 100C and (ii) the seller 122N is close to the retail environment 100C (e.g., within a threshold distance from the radius 120C and/or the retail environment 100C).

In some implementations, if the item SKUs 555, 777, 369, and 000 were clustered together and the seller 122N is only associated with selling the item SKU 777, then the seller 122N may have a confidence score that is lower than 80/100 because the seller 122N may not be selling a threshold quantity of the clustered items. In this example, seller 122B may have a higher confidence score for the retail environment 100C than the seller 122N because seller 122B is selling two items, SKUs 555 and 369, from the cluster of item SKUs associated with the shortage in the retail environment 100C. Distance, timing of the sellers' listings, and one or more other parameters described herein may affect the confidence scores of the sellers 122A-N.

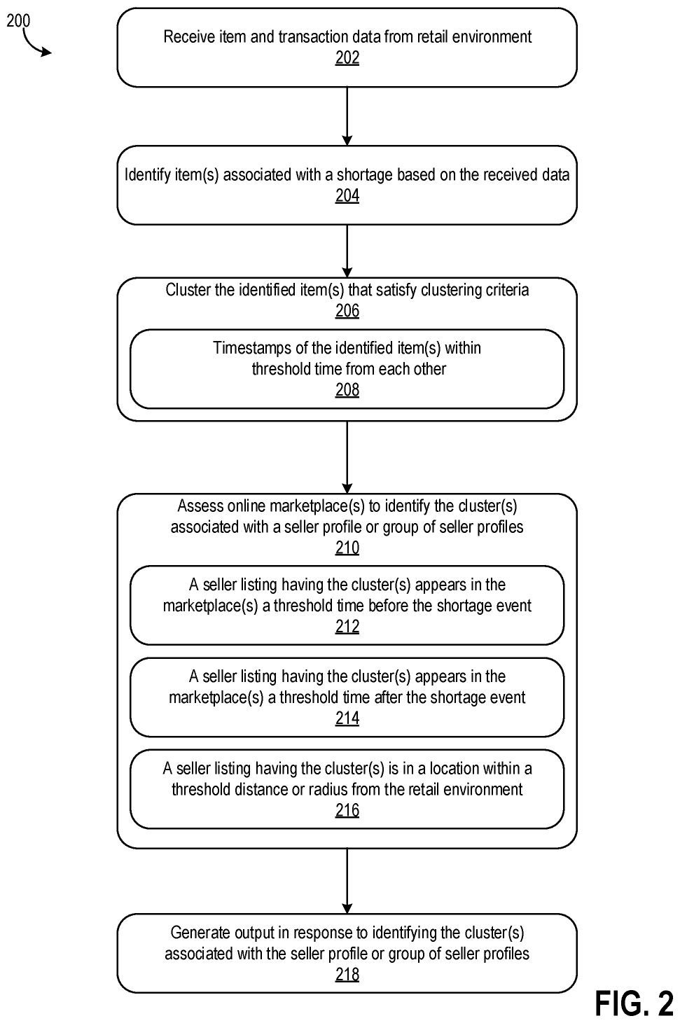

FIG. 2 is a flowchart of a process 200 for clustering items associated with a shortage in a retail environment and identifying the cluster(s) in seller listings in an online marketplace. The process 200 can be performed by the computer system 110. The process 200 can also be performed by one or more other computing systems, devices, computers, networks, cloud-based systems, and/or cloud-based services. For illustrative purposes, the process 200 is described from the perspective of a computer system.

Referring to the process 200 in FIG. 2, the computer system can receive item and transaction data from a retail environment in block 202. Refer to blocks B-C described in FIG. 1A.

In block 204, the computer system can identify at least one item associated with a shortage based on the received data. For example, the computer system can identify item SKUs (or other unique item identifiers) in the item data for items that are detected leaving the retail environment. The computer system can then search the transaction data to determine whether any of the transaction data includes the identified item SKUs. If the transaction data does not include the identified item SKUs, then the identified item SKUs are likely stolen and thus associated with the shortage in the retail environment. As described in FIG. 1A, the computer system can search transaction data that is within a threshold amount of time before and/or after times at which the items in the item data are detected. As an illustrative example, the computer system may only assess transaction data that is made/timestamped between 1-5 minutes before the timestamps of item detection in the item data. Refer to block D in FIG. 1A for additional discussion about identifying the items.

The computer system can also cluster the identified item(s) that satisfy clustering criteria in block 206. The identified items can be grouped into clusters to indicate that those items are likely taken from the retail environment by the same shopper. Since they are taken by the same shopper, they are likely to be sold by a same seller in an online marketplace. Therefore, the computer system can cluster the items and use the cluster of items to efficiently, accurately, and objectively identify seller listings in the online marketplace that include at least a threshold quantity of the items in the cluster.

The computer system can cluster the identified items based on determining whether timestamps of the identified items are within a threshold amount of time from each other (block 208). For example, if the identified items have the same timestamps, they can be clustered together as likely being carried out of the retail environment by the same shopper. As another example, if the identified items have timestamps that are within milliseconds of each other (e.g., milliseconds), they can be clustered. As another example, the identified items can be clustered if their timestamps are within 1-2 seconds of each other. One or more other threshold amounts of time can be used, including but not limited to 1 second, 2 seconds, 3 seconds, 4 seconds, 5 seconds, etc. Refer to block E in FIG. 1A for additional discussion about clustering.

The computer system can assess at least one online marketplace to identify the cluster(s) associated with a seller profile or group of seller profiles in block 210. As mentioned above, the same shopper likely leaves the retail environment with the cluster of identified items. The shopper then can sell one or more of the clustered items using one seller profile in the online marketplace. The shopper can sell each of the items in separate seller listings, however the seller listings may still be attributed to the same seller (the shopper) and oftentimes the same geographic location of the seller. In some implementations, the shopper may sell multiple items in one seller listing. The shopper may sell, for example, at least one of the clustered items and at least one other item that has not been identified as part of a shortage at the retail environment. Moreover, the shopper may sell the clustered items in the seller listings but may also sell other items not attributed to shortages in retail environments. Refer to blocks F-G in FIG. 1A for additional discussion about analyzing the online marketplace to identify seller listings having the clustered items.

To identify the cluster(s) as associated with a seller profile or group of seller profiles, the computer system can determine that a seller listing having the cluster(s) (or a threshold quantity of items in the cluster, such as at least one item in the cluster) appears in the online marketplace a threshold amount of time before the shortage event was detected/identified (block 212). Sometimes, a seller can list items for sale before they steal the items from the retail environment. The seller may do this to guarantee that they have a buyer before stealing from the retail environment. Therefore, if the seller listing having the cluster (or a threshold quantity of items in the cluster) appears in the online marketplace a threshold amount of time before the shortage event is detected (e.g., in block 204 and/or 206), then the seller listing is likely associated with the shortage and can be identified in block 212. The threshold amount of time can vary depending on one or more factors. For example, the threshold amount of time can vary depending on a geographic location of the retail environment, a physical proximity or distance of the seller from the retail environment, a quantity of items from the cluster that are being sold by the seller, etc. The threshold amount of time can be, as illustrative examples, up to 1 day before the shortage, up to 3 days before the shortage, up to 5 days before the shortage, up to 12 hours before the shortage, up to 10 hours before the shortage, up to 5 hours before the shortage, up to 1 hour before the shortage, up to 30 minutes before the shortage, etc.

Additionally or alternatively, the computer system can determine that a seller listing having the cluster(s) appears in the online marketplace a threshold amount of time after the shortage event was detected/identified (block 214). Sometimes, a seller may list an item or items for sale after they steal the item(s) from the retail environment. Therefore, if the seller listing having the cluster (or a threshold quantity of items in the cluster) appears in the online marketplace a threshold amount of time after the shortage event is detected (e.g., in block 204 and/or 206), then the seller listing is likely associated with the shortage and can be identified in block 214. The threshold amount of time can vary depending on one or more factors. For example, the threshold amount of time can vary depending on a geographic location of the retail environment, a physical proximity or distance of the seller from the retail environment, a quantity of items from the cluster that are being sold by the seller, etc. The threshold amount of time can be, as illustrative examples, up to 1 day after the shortage, up to 3 days after the shortage, up to 12 hours after the shortage, up to 10 hours after the shortage, up to 5 hours after the shortage, up to 2 hours after the shortage, up to 1 hour after the shortage, etc.

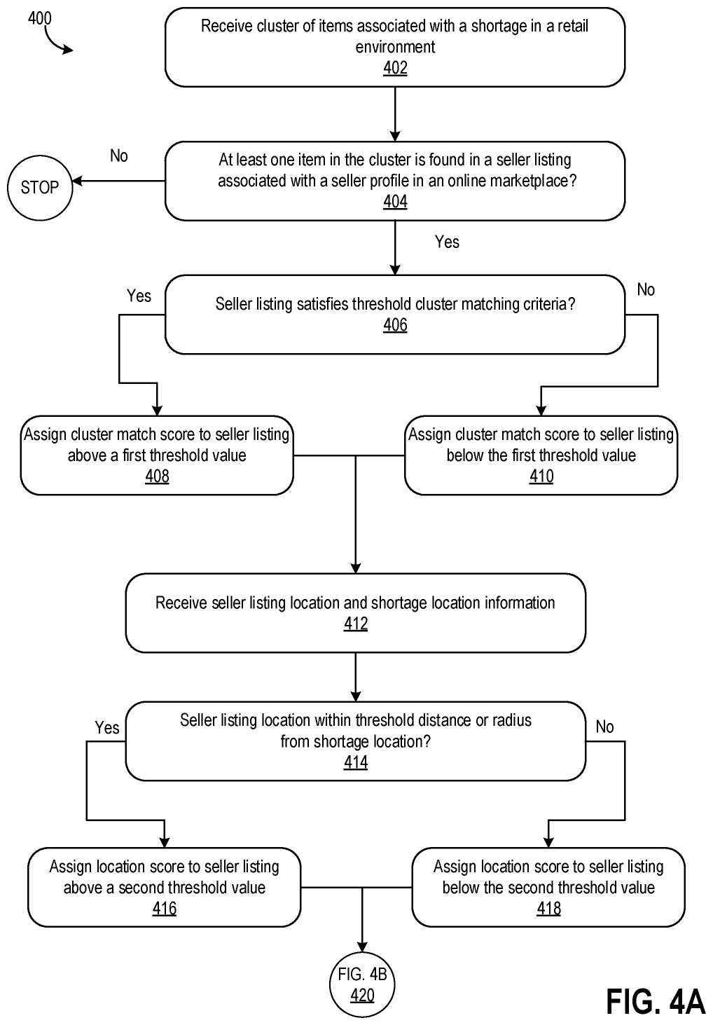

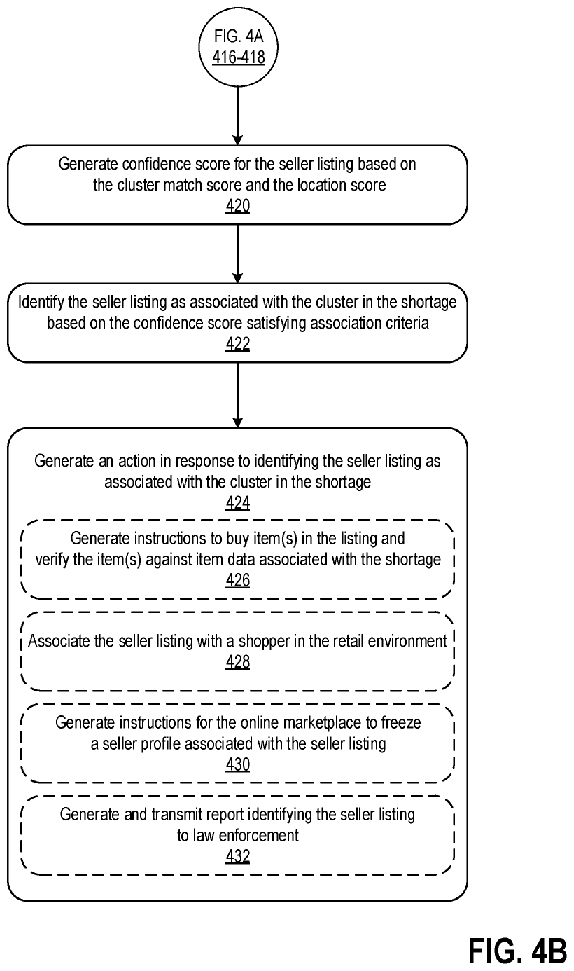

In some implementations, the threshold amount of time can be a range of time. For example, the threshold amount of time can be within 1 to 12 hours after the shortage. In some implementations, the seller listing can still be associated with the shortage if the seller listing is made/appears before or after the threshold amount of time. For example, if the seller listing having the cluster appears in the online marketplace after 12 hours (when the threshold amount of time is 1 to 12 hours), the seller listing may still be associated with the shortage, but the likelihood of this association can be lower than if the seller listing appeared within the threshold amount of time. Thus, just because the seller listing appears outside the threshold amount of time does not mean the seller listing is not associated with the shortage—the likelihood of the association merely becomes lower than if the seller listing appears within the threshold amount of time. Refer to FIGS. 4A-B for additional discussion about determining confidence scores that the seller listing is associated with the shortage based on geography and/or time criteria.

Additionally or alternatively, the computer system can determine that a seller listing having the cluster(s) is in a location within a threshold distance or radius from the retail environment (block 216). The closer the seller listing is to the retail environment having the shortage, the higher likelihood that the seller listing is associated with the shortage. The farther away the seller listing is to the retail environment, the less likely that the seller listing is associated with the shortage at the retail environment. If the seller listing is within the threshold distance or radius from the retail environment, then the seller listing can have the highest likelihood of being associated with the shortage in the retail environment. On the other hand, the farther away the seller listing is from the retail environment, the lower the likelihood.

The location associated with the seller listing can be identified in the listing. In some implementations, the location associated with the seller listing can be identified in a seller profile of the seller listing. The location can be a physical location from which the item(s) in the seller listing will be shipped/picked up. The location can be a geographic location, a town, a county, a city, GPS coordinates, or other location signals/identifiers that can be used by the online marketplace to identify the physical location of the seller associated with the seller listing or the seller listing itself.

Each retail environment can have a different threshold distance or radius. The threshold distance or radius can vary depending on where the retail environment is located. For example, a retail environment in a rural community may have a larger radius surrounding it than a retail environment in a more population-dense area, such as an urban community, town, or city. In some implementations, as shown in FIG. 1B, the radius of one or more retail environments can overlap with each other. One or more retail environments may use a threshold radius surrounding it while one or more retail environments may use a threshold distance from the retail environment for the determination in block 216. Moreover, in some implementations, the radius or distance can vary depending on a size of the retail environment. For example, a large retail environment that sells a variety of items (e.g., grocery items, electronic devices, clothing, furniture, games, sports gear, etc.) can have a larger radius or distance than a retail environment smaller in size that sells a limited quantity and/or variety of items (e.g., a grocery store).

As illustrative examples, the threshold distance and/or radius can be 1 mile, 2 miles, 3 miles, 4 miles, 5 miles, 8 miles, 10 miles, 15 miles, 20 miles, 25 miles for a particular retail environment. As another example, a first, small retail environment can have a threshold distance of 2 miles. A second, large retail environment physically close to the first retail environment can have a threshold distance of 10 miles. In some implementations the first and second retail environments can have between 1-8 miles of overlap in threshold distance or radius. Therefore, a seller listing having a location within the 1-8 miles of overlap may be associated with a shortage in either the first or second retail environments, assuming the seller listing contains at least one item in the cluster(s) associated with the first and second retail environments.

As mentioned above in reference to the threshold amount of time (block 214), if the seller listing having the cluster(s) is associated with a location that is not within the threshold distance or radius, the seller listing may still be associated with the shortage. The likelihood of the association merely is lower than if the seller listing appeared within the threshold distance or radius from the retail environment (or location of the shortage). Refer to FIGS. 4A-B for additional information about generating a score indicating likelihood that the seller listing is associated with the shortage in the retail environment based on location relative to the location of the retail environment.

In some implementations, the computer system can identify clusters based on human observations documented by employees in the retail environment. For example, an employee, such as safety and security personnel, can observe a customer putting a particular item under their clothing and walking out of the retail environment without paying for that item. The employee can document this observation at the employee's computing device (e.g., mobile device), which can be provided to the computer system. The computer system can use information documented about this observation to then identify the particular item as part of a cluster of items sold in an online marketplace.

The computer system can generate one or more scores for the seller listing in blocks 210-216, which can be used to associate the seller listing with the cluster of items identified in the item shortage. Such scoring is described further in relation to the process 400 in FIGS. 4A-B.

The computer system can generate output in response to identifying the cluster(s) associated with the seller profile or group of seller profiles in block 218. As described further in reference to the process 400 in FIGS. 4A-B, the output can include instructions to bid on or purchase the items in the seller listing. The instructions can be received at a user device of a relevant user, such as an employee of the retail environment. The employee can be tasked with ensuring safety and security in the retail environment. Once the item(s) in the seller listing are purchased, the user can scan an RFID tag on the item(s) to determine whether the item(s) matches the item(s) in the retail environment's shortage. If the purchased item(s) matches the item(s) in the shortage, the user can identify the item(s) as being stolen from the retail environment. Additional steps can also be taken by the user (or other relevant users) to objectively identify the seller of the item(s), monitor the seller, and/or apprehend the seller to prevent them from selling more items that are taken from the retail environment without being paid for. For example, the user can associate the seller with a shopper or other guest of the retail environment by reviewing video feeds or other surveillance information at or around the time of the shortage.

The output can also include instructions for the online marketplace to freeze the seller profile associated with the seller listing so that the seller can no longer sell items or receive payment for sold items. The freezing action can be for a predetermined amount of time (e.g., 5 days, 3 days, or another amount of time until the seller is identified and apprehended for selling the shortage item(s)). In some implementations, the instructions can include freezing a money account for the seller profile so that the seller cannot receive payment from buyers and/or withdraw money from their account. The freezing action can be performed for a predetermined amount of time, as mentioned above. In some implementations, the instructions can be sent to law enforcement or other third parties (e.g., a bank that maintains a banking account for the seller associated with the seller listing).

The output can also include generating a report to be sent to law enforcement with sufficient evidence for law enforcement to investigate, monitor, and/or apprehend the seller. In some implementations, the computer system can store information about the seller listing in a data store to build a repository of instances that the seller associated with the seller listing was linked to retail environment shortages. Once the repository has a sufficient amount of evidence that the seller is associated with retail environment shortages, the computer system can generate the report to be transmitted to law enforcement.

One or more other outputs are also possible, as described in reference to the process 400 in FIGS. 4A-B.

Moreover, the type of output generated by the computer system can vary based on the likelihood that the seller listing is associated with the shortage in the retail environment and the gravity of the shortage. The more likely the seller listing is associated with the shortage, the more serious intervention or output that is generated in block 218. For example, if the likelihood of association exceeds a threshold likelihood value, the computer system can generate and transmit a report for law enforcement. If the likelihood of association is less than the threshold likelihood value, then the computer system may simply generate an alert to be transmitted to the employee of the retail environment to associate a shopper with the seller and/or build a repository of instances in which the seller of the seller listing is associate with retail environment shortages.

As another example, the type of output generated can vary based on a quantity of shortage items sold in the seller listing(s). If the quantity of shortage items sold exceeds a threshold quantity, then a more serious intervention or output can be generated, as mentioned above. If the quantity of shortage items sold is less than the threshold quantity, then a less serious intervention or output can be generated.

As another example, the type of output generated can vary based on cost of the shortage items sold in the seller listing(s). The more expensive the item(s) sold in the seller listing(s), the more serious the intervention or output that is generated. For example, if a smartphone or TV is sold in the seller listing, the computer system can generate a report for law enforcement since more expensive items (e.g., the price of the smartphone or TV exceeds a threshold cost) whereas if the seller listing includes a set of plates, or other items that cost less than a threshold cost, a less serious intervention/output can be generated, such as simply storing the seller listing and seller information in a data store so that the particular seller can be monitored in the future.

As yet another example, the type of output generated can vary based on how often the seller of the seller listing has been associated with shortages in the retail environment. For example, if the seller has made a quantity of listings with shortage items that exceeds a threshold quantity of listings, a more serious intervention or output can be generated, as mentioned above. Similarly, if the seller of the listing is frequently associated with retail environment shortages (e.g., a frequency of which the seller has been associated with shortages exceeds a threshold frequency in a threshold amount of time), then a more serious intervention or output can be generated, as described herein. The type of output generated can vary based on one or more other factors as described herein.

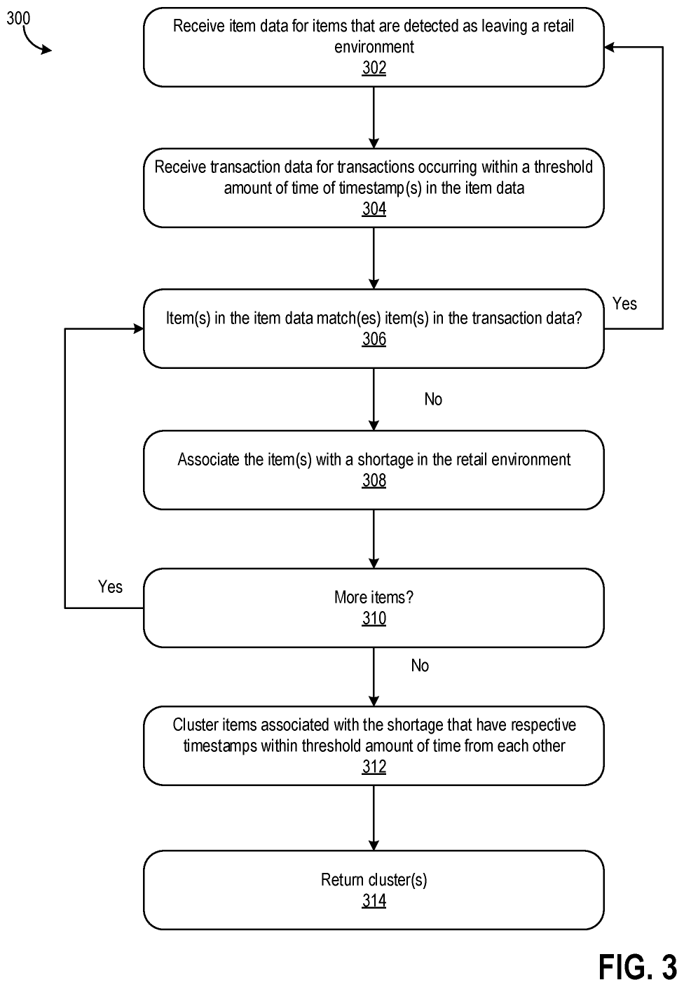

FIG. 3 is a flowchart of a process 300 for identifying items associated with a shortage in a retail environment. The process 300 can be performed by the computer system 110. The process 300 can also be performed by one or more other computing systems, devices, computers, networks, cloud-based systems, and/or cloud-based services. For illustrative purposes, the process 300 is described from the perspective of a computer system.

Referring to the process 300 in FIG. 3, the computer system can receive item data for items that are detected as leaving a retail environment (block 302). The item data can include, for each item, a unique identifier (e.g., barcode, RFID tag, SKU, other identifier), a timestamp indicating a time at which the item was detected as leaving the retail environment, and/or an item description, which can include item category, sub-category, and/or item type. Refer to blocks A-B in FIG. 1A and block 202 in the process 200 of FIG. 2 for additional discussion about receiving the item data.

The computer system can receive transaction data for transactions occurring within a threshold amount of time of one or more timestamps in the item data (block 304). The computer system can receive, for example, transaction data for transactions that occurred within 5 minutes of the timestamps of item detections in the item data. One or more threshold amounts of time can be used, including but not limited to 30 seconds before the detection, 1 minute before the detection, 2 minutes before the detection, 3 minutes before the detection, 10 minutes before the detection, 15 minutes before the detection, etc. The threshold amounts of time can vary depending on one or more factors, including but not limited to a size of the retail environment (e.g., the smaller the retail environment, the smaller the threshold amount of time), a distance between a checkout area where the transactions are completed and an exit of the retail environment (e.g., the greater the distance, the longer the threshold amount of time), a shopper/guest frequency at the retail environment (e.g., the busier the retail environment or the more shoppers, the longer the threshold amount of time), etc. Refer to block C in FIG. 1A and block 202 in the process 200 of FIG. 2 for additional discussion about receiving the transaction data.

In block 306, the computer system can determine whether the item(s) in the item data match(es) an item or items in the transaction data. If the items in the item data match the items in the transaction data, then the items that left the retail environment have been paid for as part of a transaction. Thus, the items are likely not stolen or otherwise associated with a shortage for the retail environment. The computer system can determine whether the items in the item data match the items in the transaction data by comparing item identifiers (e.g., barcode, SKU, RFID tag, other unique identifier), item types, item descriptions, item prices, and/or timestamps at which the items were detected with similar information in the transaction data. One or more receipts, labels, or other types of data in the item and transaction data can be used for matching.

For example, if an item identifier in the item data is “AA1234” and the same identifier appears in the transaction data at a timestamp that is 1 minute earlier than the time at which the item with the identifier “AA1234” was detected, then the item in the item data matches the item in the transaction data. Refer to block D in FIG. 1A and block 204 in the process 200 of FIG. 2 for additional discussion about matching items in the item data and transaction data.

If there is a match, then the computer system can return to block 302 and continue through the process 300. As mentioned above, if there's a match, then the item that was detected as leaving the retail environment has been paid for as part of a transaction and thus is not associated with a shortage in the retail environment. The computer system can continue reviewing the item data to identify items that may be associated with a shortage in the retail environment.

If the computer system determines in block 306 that the item(s) in the item data does not match the item(s) in the transaction data, the computer system can proceed to block 308, in which the computer system can associate the item(s) with a shortage in the retail environment.

The computer system can determine whether there are more items in the item data to assess (block 310). If there are more items to assess, the computer system can return to block 306.

If there are no more items to assess in the item data, the computer system can cluster the items associated with the shortage that have respective timestamps within a threshold amount of time from each other (block 312). Items that have not been matched with items in the transaction data can be clustered if they have the same or similar timestamp, thereby indicating that the clustered items have been taken out of the retail environment by the same shopper or guest. For example, items with the same timestamp can be clustered because they are likely to be taken out of the retail environment by the same shopper. As another example, items having timestamps within the threshold amount of time from each other are clustered. The threshold amount of time can vary based on one or more factors. For example, the threshold amount of time can change based on a size of the retail environment (e.g., the larger the retail environment, the longer the threshold amount of time may be to account for a physical distance a shopper may travel to exit the retail environment). The threshold amount of time can also vary depending on a quantity of shopper/guest traffic at the retail environment (e.g., the more traffic in the retail environment, the smaller the threshold amount of time so that items carried out by one shopper are not accounted for/associated with another shopper). Refer to block E in FIG. 1A and blocks 206-208 in the process 200 of FIG. 2 for additional discussion about clustering the items.

The computer system can then return the cluster(s) in block 314. Returning the clusters can include storing the clusters in a data store or other data repository. Returning the clusters can also include feeding/transmitting the clusters to a module or engine of the computer system or another computer system for additional processing. As described herein, the clusters can be used to identify e-fencing and attribute the e-fencing to shortages in the retail environment.

FIGS. 4A-B is a flowchart of a process 400 for identifying a cluster of items associated with a shortage in a seller listing in an online marketplace. The process 400 can be performed once clusters of shortage items are identified, as described in the process 300 of FIG. 3. The process 400 can be performed by the computer system 110. The process 400 can also be performed by one or more other computing systems, devices, computers, networks, cloud-based systems, and/or cloud-based services. For illustrative purposes, the process 400 is described from the perspective of a computer system.

Referring to the process 400 in both FIGS. 4A-B, the computer system can receive a cluster of items associated with a shortage in a retail environment in block 402. Block 402 can be performed after the block 314 in the process 300 of FIG. 3. The cluster of items received in block 402 can include item data such as item identifiers, item type/category, and location data for the retail environment from which the item was identified as part of the shortage.

The computer system can determine whether at least one item in the cluster is found in a seller listing with a seller profile in an online marketplace (block 404). For example, the computer system can identify APIs for online marketplaces to search. The computer system can then use the APIs to access the online marketplaces and search for seller listings that include at least one of the items in the cluster. The computer system can search the seller listings for item identifiers, item type/category information, or other identifying information about the clustered items. If, for example, a seller listing includes an item with the same identifier (e.g., UPC, barcode, SKU, other unique identifier in the description of the item), then the computer system can identify the seller listing as having the at least one item in the cluster in block 404. In block 404, the computer system can also identify the particular seller profile associated with the seller listing.

If none of the clustered items are found in seller listings, the process 400 can stop. This means that the items identified as part of the shortage in the retail environment are not being sold in the online marketplace(s).

If at least one of the clustered items is found in a seller listing, the computer system can determine whether that seller listing satisfies threshold cluster matching criteria in block 406. A cluster match score can be assigned to the seller listing based on the determination in block 406. The cluster matching criteria can vary depending on the retail environment and/or the type of item(s) in the cluster. For example, the cluster matching criteria can include a threshold quantity of items in the cluster, appearing in the seller listing (or other seller listings made by the same seller profile as the seller listing identified in block 404). The cluster matching criteria can also include a determination that unique items in the cluster are identified in the seller listing (e.g., special or limited edition items for sale in the retail environment, expensive items like watches, jewelry, electronic devices, or other items whose price exceeds a threshold value, etc.). For example, if five unique items that are rarely purchased are clustered together and appear in seller listings associated with a particular seller profile, then the seller listings associated with the seller profile likely satisfy the threshold cluster matching criteria in block 406 and can be assigned a corresponding cluster match score. The cluster matching criteria can also include a determination indicating a match of the item type in the seller listing with the item(s) in the cluster. The cluster matching criteria can also include a match of item SKU or other unique identifier.

Accordingly, if the seller listing satisfies the threshold cluster matching criteria, the computer system can assign a cluster match score to the seller listing that is above a first threshold value (block 408). The computer system can then proceed to block 412, described below. The cluster match score can be assigned on a scale, for example, from 1 to 100. In some implementations, the first threshold value can be 50 out of 100. The closer the seller listing is to satisfying the threshold cluster matching criteria, the higher the score that the seller listing is assigned. For example, if the cluster contains four items and the seller listing contains two of the four items, the seller listing can be assigned a score of 50 out of 100. If the seller listing, on the other hand, contains all four of the items, the seller listing can be assigned a score of 90 out of 100 or higher. As another example, if the seller listing contains all the unique items in the cluster, then the assigned score can be higher than if the seller listing contains only two of the unique items in the cluster.

If the seller listing does not satisfy the threshold cluster matching criteria, the computer system can assign a cluster match score to the seller listing that is below the first threshold value in block 410. In some implementations, so longer as a seller listing contains at least one item in the shortage, the seller listing can receive a score, albeit a low score. As an illustrative example, if the threshold cluster matching criteria requires the seller listing, or seller listings of the associated seller profile, to include four of five clustered items but the seller listing, or the associated seller profile, only includes one or two of the clustered items, then the seller listing can be assigned a cluster match score below the first threshold value (e.g., a score below 50 out of 100). If the seller listing includes only one of the clustered items, the seller listing can receive a lower score below 50 than if the seller listing contains two of the clustered items. After block 410, the computer system can proceed to block 412.

In block 412, the computer system can receive seller listing location and shortage location information. Sometimes block 412 can occur at the same time as block 404. For example, in block 404, the computer system can retrieve seller listing data for online marketplaces. The seller listing data can include seller profile information, which can include seller location information. The seller location information can include an address, GPS coordinates, a city, town, county, state, country, zip code, or other type of address or location-identifying information. The shortage location information can indicate a location of the retail environment where the shortage was identified. The shortage location information can be received in block 402, in some implementations. For example, the shortage location information can be received as part of the cluster of items associated with the shortage. The shortage location information can include an address, GPS coordinates, city, town, county, state, country, zip code, or other type of location-identifying information. In some implementations, the shortage location information can also include a threshold distance or radius around the retail environment where the shortage was identified.

The computer system can determine whether the seller listing location is within a threshold distance or radius from the shortage location in block 414. A location score can be assigned to the seller listing based on a distance of the seller listing from the retail environment. The computer system can compare the seller listing location to the shortage location information. The computer system can determine whether the seller listing location is the same as the shortage location information (e.g., a same zip code, town, city, county, street, etc.). The computer system can also determine whether the seller listing location is within the threshold distance or radius from the shortage location information. The more physically proximate the seller listing location is to the shortage location, the higher the location score that is assigned to the seller listing. The farther away the seller listing location is to the shortage location, the lower the location score that is assigned to the seller listing.

Accordingly, if the seller listing location is within the threshold distance or radius, the computer system can assign a location score to the seller listing that is above a second threshold value (block 416). The computer system can then proceed to block 420, described below. In some implementations, the second threshold value can be 50 out of 100. If the seller listing location is within the threshold distance or radius from the retail environment, then the seller listing's location score can be assigned a value between 50 and 100. The closer the seller location is to the retail environment, the higher the value assigned to the location score. For example, if the seller listing location is within one mile from the retail environment, the seller listing can be assigned a location score between 90 and 100. As another example, if the seller listing is on the edge of the retail environment's radius (e.g., at five miles away from the retail environment), then the seller listing can be assigned a score closer to 50 out of 100.

If the seller listing location is not within the threshold distance or radius, the computer system can assign a location score that is below the second threshold value (block 418). As mentioned with regards to blocks 406-410, the seller listing can be assigned the location score regardless of a distance of the seller listing from the retail environment since the seller listing contains at least one item in the cluster—thus, the seller listing is likely associated with the shortage in the retail environment. The value of the location score varies depending on how close or far away the seller listing is from the retail environment. As an illustrative example, if the second threshold value is 50 out of 100, the threshold distance from the retail environment is 10 miles, and the seller listing location is 12 miles from the retail environment, the seller listing may receive a location score that is between 1 and 50 (e.g., such as a score of 40). The farther out the seller listing is located from the threshold distance or radius of the retail environment, the lower the location score. The computer system can then proceed to block 420.

Blocks 414-418 can be performed before blocks 406-410. In some implementations, blocks 414-418 can be performed at a same time as blocks 406-410. Moreover, in some implementations, instead of generating and assigning location scores in blocks 416-418, the computer system can adjust the cluster match scores that were previously assigned in blocks 408-410. For example, instead of assigning the location score above the second threshold value, the computer system can increase the cluster match score by a predetermined amount. For example, a seller listing can receive a cluster match score of 70 out of 100 for having three of five clustered items. The seller listing's location can be one mile from the retail environment and thus within the threshold distance from the retail environment. Therefore, the cluster match score can be increased to 90 out of 100, thereby indicating higher likelihood that the seller listing (and the associated seller profile) is associated with the shortage in the retail environment. Instead of assigning the location score below the second threshold value, the computer system can decrease the cluster match score by a predetermined amount based on the distance of the seller listing from the retail environment. In the above example, if the seller listing is located two miles out of the threshold radius of the retail environment, the cluster match score associated with the seller listing can be reduced from 70 out of 100 to 50 out of 100. The reduction in the cluster match score can indicate that the seller listing is still likely associated with the shortage in the retail environment, but that the location of the seller listing makes the association less likely than a seller listing that contains items from the cluster and is closer to the physical location of the retail environment.

In some implementations, the computer system can also adjust the cluster match score or the location score and/or assign a time score to the seller listing based on whether the seller listing was made/appears in the online marketplace within a threshold amount of time from the shortage event. Refer to blocks 212-214 in the process 200 of FIG. 2 for additional information.

As mentioned above, the scores that are generated and/or assigned in blocks 408, 410, 416, and 418 can be determined based on how close the seller listing is to satisfying the threshold criteria or other values. For example, the more threshold cluster matching criteria that the seller listing satisfies, the higher the cluster match score that is assigned to the seller listing. The less threshold cluster matching criteria that is satisfied, the lower the cluster match score.

Still referring to the process 400, in block 420, the computer system can generate a confidence score for the seller listing based on the cluster match score and/or the location score. The confidence score can indicate a likelihood that the seller listing is associated with the shortage. In some implementations, the cluster match score and the location score can be averaged to determine the confidence score. Sometimes, the cluster match score and the location score can be summed. In some implementations, the cluster match score and the location score can be weighted then summed or averaged. In yet some implementations, a highest of the two scores can be selected as the confidence score for the seller listing. As mentioned above, sometimes the computer system can simply generate one score for the seller listing instead of generating separate scores that are then combined into the confidence score.

In block 422, the computer system can identify the seller listing as being associated with the cluster in the shortage based on the confidence score satisfying association criteria. The computer system can select the seller listing having the highest confidence score. In some implementations, the computer system can select various seller listings having confidence scores within a threshold range (e.g., seller listings with top 5 scores). In some implementations, the computer system can select the seller listing having a cluster match score that satisfies a first threshold association criteria and a location score that satisfies a second threshold association criteria. The association criteria can include a threshold confidence score value. The association criteria can also include a threshold quantity of items from the cluster being associated with the seller listing or the seller profile. The association criteria can also include the seller listing being a threshold distance from the retail environment. One or more other association criteria can also be used to identify the seller listing in block 422.

The computer system can also generate an action (or actions) in response to identifying the seller listing as being associated with the cluster in the shortage (block 424). Refer to block H in FIG. 1A and block 218 in FIG. 2 for additional discussion. For example, the computer system can optionally generate instructions to buy the item(s) in the seller listing and verify the item(s) against item data associated with the shortage (block 426). The instructions can be transmitted to a user device of an employee in the retail environment. The employee can then purchase the item(s) and once the item(s) is received, compare the item(s) data, such as an associated RFID tag, to data for items identified in the shortage. Performing these instructions can be beneficial to verify that the shortage in fact occurred in the retail environment. Performing these instructions can also be beneficial to get the shortage items back after they have been stolen or otherwise taken from the retail environment. In some implementations, performing these instructions can also be beneficial to identify the seller and associate the seller with a customer or other guest in the retail environment. As a result, the customer or other guest can be monitored and/or apprehended if and when they return to the retail environment.

Additionally or alternatively, the computer system can optionally associate the seller listing with a shopper in the retail environment (block 428). For example, information in the seller profile associated with the seller listing can be used to identify the shopper or other guest in the retail environment. As another example, if the seller listing is likely associated with the shortage in the retail environment, then the computer system can retrieve image or video data from the retail environment around a time at which the shortage in the retail environment was identified. The image or video data can be processed and analyzed to identify the shopper or other guest who exited the retail environment at the time of the shortage. The identified shopper or other guest can then be matched with the seller profile associated with the seller listing. One or more other techniques can be used to objectively identify and correlate the seller profile of the seller listing with a customer or other guest in the retail environment.

Additionally or alternatively, the computer system can optionally generate instructions for the online marketplace to freeze a seller profile associated with the seller listing (block 430). For example, depending on a value of the seller listing confidence score, such instructions can be generated. If the confidence score exceeds a threshold value (e.g., the score is at or above 90 out of 100), then the instructions can be generated in block 430 because the associated seller is most likely associated with the shortage and therefore should be apprehended or stopped from continuing with their online activities. If, on the other hand, the seller listing has a confidence score that is less than the threshold value, the instructions may not be generated in block 430 since not enough evidence may be collected indicating likelihood that the seller listing is associated with the shortage.

Additionally or alternatively, the computer system can optionally generate and transmit a report identifying the seller listing to law enforcement (block 432). As described in relation to block 430, the report can be generated and/or transmitted to law enforcement if the confidence score associated with the seller listing exceeds some threshold value. If the confidence score exceeds the threshold value, then the seller listing is most likely associated with the shortage and a sufficient amount of evidence may exist that supports this association. Therefore, preventative action can be taken to track, monitor, and/or apprehend the seller associated with the seller listing.

Sometimes, if the confidence score is less than the threshold value in block 432, for example, the computer system can store information about the association (e.g., the confidence score, the item data associate with the shortage, the seller listing information, etc.) in a data store. The information can be stored in association with the seller (e.g., using a unique identifier assigned to the seller by the computer system) to build a record of evidence demonstrating that the seller is associated with shortages in the retail environment. Eventually, when a sufficient/threshold amount of evidence is collected in association with the particular seller, the computer system can generate one or more of the actions described in blocks 424-432.

One or more other actions can be generated in block 424, as described in reference to the process 200 in FIG. 2.

Moreover, in some implementations, the computer system can generate the scores for a seller profile associated with the identified seller listing. Thus, the seller profile can be scored and associated with the shortage in the retail environment rather than particular seller listings. One or more other scoring variations are also possible, as described throughout this disclosure.

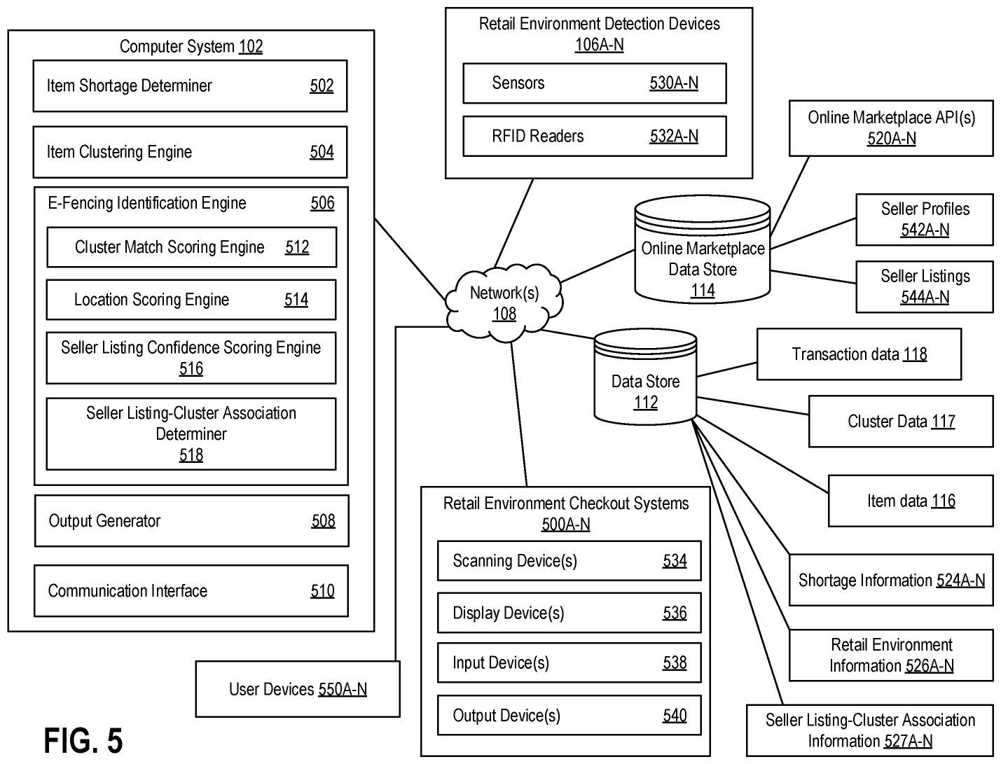

FIG. 5 is a system diagram of components used to perform the techniques described herein. The computer system 102, retail environment detection devices 106A-N, data store 112, online marketplace data store 114, and retail environment checkout systems 500A-N can communicate (e.g., wired and/or wireless) via network(s) 108.

In brief, the retail environment detection devices 106A-N can be positioned in retail environments at or around exits of the retail environments. The devices 106A-N can include sensors 530A-N and RFID readers 532A-N. The sensors 530A-N can be configured to detect one or more attributes or features of items as the items are moved around an exit of the retail environment. For example, the sensors 530A-N can include cameras configured to capture images of items as they exit the retail environment. The sensors 530A-N can also include barcode scanners or other readers configured to detect and/or scan barcodes or other unique identifiers that are affixed to items that exit the retail environment. The RFID readers 532A-N can be configured to detect and/or read RFIG tags affixed to items that are within a threshold distance from the readers 532A-N (e.g., in, around, or near the exit of the retail environment). Refer to FIG. 1A for additional discussion about the devices 106A-N.

The retail environment checkout systems 500A-N can be positioned near the exit of the retail environment. The checkout systems 500A-N can be self-checkout lanes and/or manual checkout lanes. Each of the checkout systems 500A-N can include scanning device(s) 534, display device(s) 536, input device(s) 538, and output device(s) 540. The scanning device(s) 534 can include any type of device for scanning items to be purchased, including but not limited to barcode scanners, handheld scanning devices, flatbed scanners, weight scales, cameras, or other types of devices for scanning labels/tags/identifiers affixed to items to be purchased and/or for scanning the items themselves. The display device(s) 536 can include any type of display, including but not limited to a display screen, touch screen, or audio output. The display device(s) 536 can present transaction data to a customer as their items are scanned. The display device(s) 536 can also present the customer with selectable options to manually enter items to be purchased, modify their transaction data (e.g., remove items from purchase), and/or pay for the items that have been scanned. The input device(s) 538 can include any type of input device for the customer to provide information during the checkout process, including but not limited to a touch screen, a keyboard, a mouse, a microphone, and/or a scanning device. The output device(s) 540 can be the same as or similar to the display device(s) 536. The output device(s) 540 can provide and/or present information to the customer about the checkout process and their transaction data. In some implementations, information about the transaction and checkout process can also be transmitted from the checkout system 500A-N to a user device (e.g., mobile phone) of the customer, such as user devices 550A-N. The transaction data can be presented in a mobile application at the user device 550A-N and/or the user can complete the checkout process by paying for the transaction through a mobile wallet in the mobile application at the user device 550A-N. Refer to FIG. 1A for additional discussion about the checkout systems 500A-N.

The computer system 102 can be configured to identify items in a shortage in a retail environment, cluster the identified shortage items, and identify whether the cluster of shortage items are being sold in online marketplaces. The computer system 102 can include an item shortage determiner 502, an item clustering engine 504, an e-fencing identification engine 506, an output generator 508, and a communication interface 510.

The item shortage determiner 502 can be configured to identify items that are part of shortage events in a retail environment. For example, the determiner 502 can receive item data for detected barcodes, identifiers, RFID tags, or other unique item identifiers from the retail environment detection devices 106A-N. The determiner 502 can also receive transaction data from the checkout systems 500A-N from around same or similar timestamps as the item data from the detection devices 106A-N. The determiner 502 can compare the transaction data with the item data to identify items that were detected by the detection devices 106A-N but do not correspond to purchased items in the transaction data. The identified items can be part of the shortage in the retail environment.

In some implementations, the item data can be stored in the data store 112 as item data 116 when the items are detected by the detection devices 106A-N. Similarly, when checkout processes are completed, the checkout systems 500A-N can transmit the transaction data to the data store 112 to be stored as transaction data 118. The item shortage determiner 502 can then retrieve the item data 116 and the transaction data 118 from the data store 112 to identify what items are part of a shortage in the retail environment.

Items identified as part of the shortage can be stored as shortage information 524A-N in the data store 112. The shortage information 524A-N can include, for example, item identifiers (e.g., barcode, RFID tag, etc.), item type, item category, timestamp at which the item was detected as leaving the retail environment, etc. Refer to blocks B-D in FIG. 1A for additional information about identifying items in the shortage.

The item clustering engine 504 can receive the shortage information 524A-N from the item shortage determiner 502 or from the data store 112. The engine 504 can also receive the transaction data 118 from the data store 112. Using the shortage information 524A-N and the transaction data 118, the engine 504 can determine which items in the shortage left the retail environment at a same timestamp and cluster those items. The items that left the retail environment at the same time can be clustered and thus are likely associated with a same customer or guest in the retail environment. If any of the clustered items are to be sold in online marketplaces, they are likely to be sold or offered for sale by a same seller profile. The clustered items can be stored as cluster data 117 in the data store 112. The cluster data 117 can include information such as item identifiers, item types, item RFID tags, item categories, etc. Refer to block E in FIG. 1A for additional information about clustering the shortage items.

The e-fencing identification engine 506 can be configured to determine whether a cluster of items or at least one item in the cluster appears in a seller listing in an online marketplace. The engine 506 can receive data from the online marketplace data store 114 to make this determination. For example, the engine 506 can retrieve online marketplace APIs 520A-N, seller profiles 542A-N, and seller listings 544A-N from the data store 114. The APIs 520A-N can be used by the engine 506 to access, query, and/or search the various seller listings 544A-N that are generated by the seller profiles 542A-N and appear in the respective online marketplaces. The engine 506 can also retrieve the shortage information 524A-N, cluster data 117, and retail environment information 526A-N from the data store 112. The retail environment information 526A-N can include location information, for example, which can be used to determine whether a seller listing is geographically proximate to the retail environment and thus likely associated with the shortage therein. The engine 506 can include a cluster match scoring engine 512, a location scoring engine 514, a seller listing confidence scoring engine 516, and a seller listing-cluster association determiner 518.

The cluster match scoring engine 512 can be configured to search the seller listings 544A-N and identify which, if any, of the seller listings include at least one of the clustered items from the cluster data 117. The engine 512 can then determine a cluster match score for the identified seller listing, wherein the score indicates how likely the seller listing matches the cluster data 117. For example, a seller listing containing multiple items from the cluster can be assigned a higher cluster match score than a seller listing containing only one item from the cluster. Similarly, seller listings made by the same seller profile that each contain at least one clustered item can be assigned higher cluster match scores than seller listings made by the same seller profile in which only one of the seller listings contains a clustered item. The cluster match scores can be stored for the corresponding seller listings as seller listing-cluster association information 527A-N in the data store 112.

The location scoring engine 514 can be configured to determine, for each of the seller listings identified by the cluster match scoring engine 512, a distance between the seller listing and the retail environment. The engine 514 can use location information associated with the respective seller listings 544A-N and/or location information in the seller profiles 542A-N that correspond to the seller listings 544A-N. The engine 514 can also use location information of the retail environment, which can be part of the retail environment information 526A-N. The engine 514 can also determine a location score per seller listing based on the determined distance. The greater the distance between the location of the seller listing and the retail environment, the lower the location score. The smaller the distance between the location of the seller listing and the retail environment, the higher the location score. The location score can be stored for the corresponding seller listing in the seller listing-cluster association information 527A-N in the data store 112.

The seller listing confidence scoring engine 516 can generate an overall score for the seller listing identifying a likelihood that the seller listing is associated with the shortage in the retail environment. As described in reference to the process 400 in FIGS. 4A-B, the confidence score can be an aggregation, summation, and/or average of the cluster match score and the location score for a particular seller listing. The confidence score can be stored for the corresponding seller listing in the seller listing-cluster association information 527A-N in the data store 112.

The seller listing-cluster association determiner 518 can determine whether the confidence score for a seller listing satisfies association criteria, as described in reference to the process 400 in FIGS. 4A-B. The determiner 518 can therefore make associations between seller listings from the seller listings 544A-N and the clustered items corresponding to shortages in the retail environment from the cluster data 117. The association between the seller listing and the cluster can be stored as part of the seller listing-cluster association information 527A-N. Refer to blocks F-G in FIG. 1A and other description throughout this disclosure for additional discussion about identifying e-fencing by the e-fencing identification engine 506.

The output generator 508 can be configured to generate output and/or responses to the seller listing-cluster associations made by the seller listing-cluster association determiner 518. Refer to block H in FIG. 1A and blocks 424-432 in the process 400 of FIGS. 4A-B for additional discussion about generating output based on the e-fencing determination/identification. Output generated by the generator 508 can be transmitted to user devices 550A-N of relevant users, such as employees, in the retail environment. The generated output can also be transmitted to computing devices of law enforcement. In some implementations, the generated output can be transmitted to computing systems that operate an online marketplace hosting the seller listing that was identified in association with the cluster of items. The output can also be transmitted to computing systems that operate banking accounts or other accounts associated with the seller profiles 542A-N of the seller listings 544A-N.

Finally, the communication interface 510 of the computer system 102 can provide communication between the components described herein.

The user devices 550A-N can include any type of mobile device, including but not limited to mobile phones, smart phones, cell phones, laptops, tablets, and/or wearable devices (e.g., smart watch, smart bracelet, etc.). In some implementations, the user devices 550A-N may also include computers or other computing systems. The user devices 550A-N can communicate (e.g., wired and/or wirelessly) with any of the components described herein via the network(s) 108.

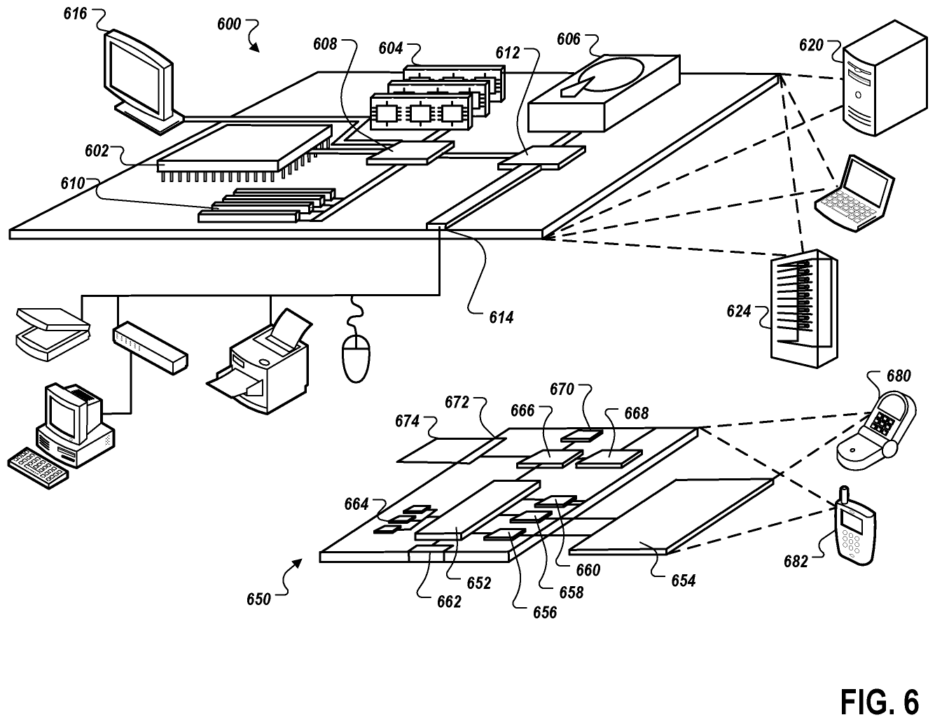

FIG. 6 shows an example of a computing device 600 and an example of a mobile computing device that can be used to implement the techniques described here. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the computing device 600. In some implementations, the storage device 606 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In the implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. In addition, it can be implemented in a personal computer such as a laptop computer 622. It can also be implemented as part of a rack server system 624. Alternatively, components from the computing device 600 can be combined with other components in a mobile device (not shown), such as a mobile computing device 650. Each of such devices can contain one or more of the computing device 600 and the mobile computing device 650, and an entire system can be made up of multiple computing devices communicating with each other.

The mobile computing device 650 includes a processor 652, a memory 664, an input/output device such as a display 654, a communication interface 666, and a transceiver 668, among other components. The mobile computing device 650 can also be provided with a storage device, such as a micro-drive or other device, to provide additional storage. Each of the processor 652, the memory 664, the display 654, the communication interface 666, and the transceiver 668, are interconnected using various buses, and several of the components can be mounted on a common motherboard or in other manners as appropriate.

The processor 652 can execute instructions within the mobile computing device 650, including instructions stored in the memory 664. The processor 652 can be implemented as a chipset of chips that include separate and multiple analog and digital processors. The processor 652 can provide, for example, for coordination of the other components of the mobile computing device 650, such as control of user interfaces, applications run by the mobile computing device 650, and wireless communication by the mobile computing device 650.

The processor 652 can communicate with a user through a control interface 658 and a display interface 656 coupled to the display 654. The display 654 can be, for example, a TFT (Thin-Film-Transistor Liquid Crystal Display) display or an OLED (Organic Light Emitting Diode) display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 650 with other devices. The external interface 662 can provide, for example, for wired communication in some implementations, or for wireless communication in other implementations, and multiple interfaces can also be used.

The memory 664 stores information within the mobile computing device 650. The memory 664 can be implemented as one or more of a computer-readable medium or media, a volatile memory unit or units, or a non-volatile memory unit or units. An expansion memory 674 can also be provided and connected to the mobile computing device 650 through an expansion interface 672, which can include, for example, a SIMM (Single In Line Memory Module) card interface. The expansion memory 674 can provide extra storage space for the mobile computing device 650, or can also store applications or other information for the mobile computing device 650. Specifically, the expansion memory 674 can include instructions to carry out or supplement the processes described above, and can include secure information also. Thus, for example, the expansion memory 674 can be provide as a security module for the mobile computing device 650, and can be programmed with instructions that permit secure use of the mobile computing device 650. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 can communicate wirelessly through the communication interface 666, which can include digital signal processing circuitry where necessary. The communication interface 666 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 668 using a radio-frequency. In addition, short-range communication can occur, such as using a Bluetooth, WiFi, or other such transceiver (not shown). In addition, a GPS (Global Positioning System) receiver module 670 can provide additional navigation- and location-related wireless data to the mobile computing device 650, which can be used as appropriate by applications running on the mobile computing device 650.

The mobile computing device 650 can also communicate audibly using an audio codec 660, which can receive spoken information from a user and convert it to usable digital information. The audio codec 660 can likewise generate audible sound for a user, such as through a speaker, e.g., in a handset of the mobile computing device 650. Such sound can include sound from voice telephone calls, can include recorded sound (e.g., voice messages, music files, etc.) and can also include sound generated by applications operating on the mobile computing device 650.

The mobile computing device 650 can be implemented in a number of different forms, as shown in the figure. For example, it can be implemented as a cellular telephone 680. It can also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for identifying items likely stolen from a physical retail environment in an online marketplace, the system comprising:
a checkout station having at least one scanning device and a point of sale (POS) terminal, the checkout station being configured to scan items during a checkout process and generate transaction data upon completion of the checkout process;
item detection sensors near an exit of a physical retail environment configured to detect item identification tags fixed to the items that leave the physical retail environment; and
a computer system in communication with the checkout station and the item detection sensors, the computer system configured to identify items likely stolen from the physical retail environment in an online marketplace, the computer system configured to perform operations comprising:
receiving, from the item detection sensors, item data indicating the items detected by the item detection sensors as leaving the physical retail environment, wherein the item data includes at least, for each item in the item data, an item identifier, an item type, and a timestamp at which the item was detected as leaving the physical retail environment;
receiving, from the checkout station, the transaction data for checkout processes that have been completed at the checkout station;
identifying a subset of items in the item data that do not match items in the transaction data as an item shortage in the physical retail environment;
grouping items in the subset of items into a cluster based on a determination that the grouped items have timestamps within a threshold amount of time from each other;
retrieving, from a server system hosting an online marketplace, seller listing data for the online marketplace, wherein the seller listing data comprises groups of items offered for sale in the online marketplace that are each associated with a different one of a plurality of online seller profiles;
comparing the cluster to each of the groups of items associated with the plurality of online seller profiles to determine cluster similarity scores for each of the groups of items;
identifying, based on the cluster similarity scores, a particular group of items and a particular corresponding seller profile as having a greatest likelihood of listing the cluster of items in the online marketplace; and
returning output in response to identifying the particular group of items and the particular corresponding seller profile that, when transmitted to a user computing device, causes the user computing device to perform an action based on the particular group of items as likely being stolen from the physical retail environment.

2. The system of claim 1, wherein the transaction data is received in real-time, as the checkout processes are completed at the checkout station.

3. The system of claim 1, wherein the transaction data is received for a subset of checkout processes that are completed within a threshold amount of time from the timestamp for each item in the item data.

4. The system of claim 1, wherein the transaction data includes, for each completed checkout process, at least a timestamp at which the checkout process was completed and a list of item identifiers for items purchased during the checkout process.

5. The system of claim 1, wherein the seller listing data further comprises, for each different one of the plurality of online seller profiles, a seller ID associated with the online seller profile, a list of item SKUs sold by the online seller profile, and a geographic location associated with the seller ID.

6. The system of claim 1, wherein identifying, based on the cluster similarity scores, a particular group of items and a particular corresponding seller profile as having a greatest likelihood of listing the cluster of items in the online marketplace comprises determining, based on the retrieved seller listing data, that the particular group of items was listed in the online marketplace by the particular seller profile within a threshold amount of time before the item shortage was identified in the physical retail environment.

7. The system of claim 1, wherein identifying, based on the cluster similarity scores, a particular group of items and a particular corresponding seller profile as having a greatest likelihood of listing the cluster of items in the online marketplace comprises determining that the particular group of items was listed in the online marketplace by the particular seller profile within a threshold amount of time after the item shortage was identified in the physical retail environment.

8. The system of claim 1, wherein identifying, based on the cluster similarity scores, a particular group of items and a particular corresponding seller profile as having a greatest likelihood of listing the cluster of items in the online marketplace comprises determining that a geographic location associated with the particular seller profile is within a threshold distance from the physical retail environment.

9. The system of claim 1, wherein identifying, based on the cluster similarity scores, a particular group of items and a particular corresponding seller profile as having a greatest likelihood of listing the cluster of items in the online marketplace comprises determining that a geographic location associated with the particular seller profile is within a threshold radius from the physical retail environment.

10. The system of claim 1, wherein comparing the cluster to each of the groups of items associated with the plurality of online seller profiles to determine cluster similarity scores for each of the groups of items comprises:
assigning a cluster match score to one of the plurality of online seller profiles above a first threshold value based on a determination that the online seller profile includes a threshold quantity of the cluster of items;
assigning a location score to the online seller profile above a second threshold value based on a determination that a geographic location of the online seller profile is within a threshold distance from a geographic location of the physical retail environment; and
generating a cluster similarity score for the online seller profile based on aggregating the cluster match score and the location score, wherein the cluster similarity score indicates a likelihood that the online seller profile is associated with the item shortage in the physical retail environment.

11. The system of claim 1, wherein identifying, based on the cluster similarity scores, a particular group of items and a particular corresponding seller profile as having a greatest likelihood of listing the cluster of items in the online marketplace comprises identifying the particular corresponding seller profile having a cluster similarity score that exceeds a threshold confidence value.

12. The system of claim 1, wherein returning output in response to identifying the particular group of items and the particular corresponding seller profile comprises generating instructions that, when transmitted and executed at the user computing device, causes the user computing device to purchase one or more items in the particular group of items, wherein the purchased one or more items are compared to the cluster to verify that the purchased one or more items correspond to the cluster of items identified in the item shortage in the physical retail environment.

13. The system of claim 1, wherein returning output in response to identifying the particular group of items and the particular corresponding seller profile comprises associating a seller ID linked to the particular seller profile with a shopper in the physical retail environment, wherein the shopper is objectively identified in the physical retail environment, by the computer system, based on at least one of image data of the shopper in the physical retail environment and an objective identifier associated with the shopper, the objective identifier being at least one of a MAC address of a mobile device of the shopper, an email address, a phone number, and a credit card number.

14. The system of claim 1, wherein returning output in response to identifying the particular group of items and the particular corresponding seller profile comprises generating instructions that, when executed at the user computing device, cause an actor in the online marketplace to freeze the particular seller profile for a threshold period of time to prevent the particular seller profile from at least one of selling items, completing sales, and receiving payment from buyers.

15. The system of claim 1, wherein returning output in response to identifying the particular group of items and the particular corresponding seller profile comprises:
generating a report for law enforcement identifying the particular group of items, the particular seller profile, and items associated with the item shortage in the physical retail environment; and
transmitting the report to a law enforcement computing device for use in investigating and stopping the particular seller profile from selling the particular group of items associated with the item shortage in the physical retail environment.

16. The system of claim 1, wherein the item detection sensors comprise RFID readers positioned (i) inside the physical retail environment near an exit of the physical retail environment and (ii) outside the physical retail environment near the exit of the physical retail environment.

17. The system of claim 1, wherein each of the online seller profiles identifies a geographic location for a corresponding seller, and
the computer system is further configured to perform operations comprising:
selecting a subset of the seller profiles with geographic locations that are within a threshold distance of the physical retail environment; and
comparing the cluster to each of the groups of items associated with the sub set of seller profiles to determine cluster similarity scores for each of the groups of items.

18. A method for identifying items likely stolen from a physical retail environment in an online marketplace, the method comprising:
receiving, from item detection sensors near an exit of a physical retail environment configured to detect item identification tags fixed to items that leave the physical retail environment, item data indicating the items detected by the item detection sensors as leaving the physical retail environment, wherein the item data includes at least, for each item in the item data, an item identifier, an item type, and a timestamp at which the item was detected as leaving the physical retail environment;
receiving, from a checkout station configured to scan items during a checkout process and generate transaction data upon completion of the checkout process, the transaction data for checkout processes that have been completed at the checkout station;
identifying a subset of items in the item data that do not match items in the transaction data as an item shortage in the physical retail environment;
grouping items in the subset of items into a cluster based on a determination that the grouped items have timestamps within a threshold amount of time from each other;
retrieving, from a server system hosting an online marketplace, seller listing data for the online marketplace, wherein the seller listing data comprises groups of items offered for sale in the online marketplace that are each associated with a different one of a plurality of online seller profiles;
comparing the cluster to each of the groups of items associated with the plurality of online seller profiles to determine cluster similarity scores for each of the groups of items;
identifying, based on the cluster similarity scores, a particular group of items and a particular corresponding seller profile as having a greatest likelihood of listing the cluster of items in the online marketplace; and
returning output in response to identifying the particular group of items and the particular corresponding seller profile that, when transmitted to a user computing device, causes the user computing device to perform an action based on the particular group of items as likely being stolen from the physical retail environment.

19. The method of claim 18, wherein returning output in response to identifying the particular group of items and the particular corresponding seller profile comprises associating a seller ID linked to the particular seller profile with a shopper in the physical retail environment, wherein the shopper is objectively identified in the physical retail environment, by the computer system, based on at least one of image data of the shopper in the physical retail environment and an objective identifier associated with the shopper, the objective identifier being at least one of a MAC address of a mobile device of the shopper, an email address, a phone number, and a credit card number.

20. The method of claim 18, wherein identifying, based on the cluster similarity scores, a particular group of items and a particular corresponding seller profile as having a greatest likelihood of listing the cluster of items in the online marketplace comprises determining that a geographic location associated with the particular seller profile is within a threshold distance from the physical retail environment.
